(19) United States
(12) Patent Application Publication
(10) Pub. No.: US 2026/0342122 A1
(43) Pub. Date: Oct. 29, 2026

(54) METHOD, SYSTEM, AND APPARATUS FOR BATTERY CHARGING, VEHICLE, ELECTRONIC DEVICE, AND STORAGE MEDIUM

(71) Applicant: CHONGQING CHANGAN AUTOMOBILE CO., LTD., Chongqing (CN)

(72) Inventors: Xiuyang LIU, Chongqing (CN); Da ZHOU, Chongqing (CN); Kai ZHANG, Chongqing (CN)

(73) Assignee: CHONGQING CHANGAN AUTOMOBILE CO., LTD., Chongqing (CN)

(21) Appl. No.: 19/377,070

(22) Filed: Nov. 3, 2025

Related U.S. Application Data
(63) Continuation of application No. PCT/CN2025/122743, filed on Sep. 19, 2025.

(30) Foreign Application Priority Data
Apr. 27, 2025 (CN) 202510536766.X

(51) Int. Cl. H02J 7/96; G07C 5/00; G07C 5/08

(52) U.S. Cl. CPC H02J 7/96; G07C 5/008; G07C 5/0816

(57) ABSTRACT

The present application relates to a method, system, apparatus for battery charging, a vehicle, an electronic device, and a storage medium, which relates to the technical field of vehicles. The method includes: receiving operational information of low-voltage devices and a current state of a vehicle from the vehicle; where the low-voltage devices include a low-voltage storage battery and a DC conversion device; determining whether the low-voltage storage battery requires charging based on the operational information of the low-voltage devices and the current state of the vehicle; and when determining that the low-voltage storage battery requires charging, sending a high-voltage power-on instruction to the vehicle to enable the vehicle to charge the low-voltage storage battery via the DC conversion device, thereby enabling reasonable charging of the low-voltage storage battery and avoiding a waste of high-voltage energy consumption.

### CROSS-REFERENCE TO RELATED APPLICATIONS

This application is a continuation of International Application No. PCT/CN2025/122743, filed on Sep. 19, 2025, which claims priority to the Chinese Patent Application No. 202510536766.X, filed with the China National Intellectual Property Administration on Apr. 27, 2025, and entitled “Method, System, and Apparatus for Battery Charging, Vehicle, Electronic Device, and Storage Medium”. The disclosure of the aforementioned applications are hereby incorporated by reference in their entireties.

### BACKGROUND

### Technical Field

The present application relates to the technical field of vehicles, and in particular, to a method, system, and apparatus for battery charging, a vehicle, an electronic device, and a storage medium.

### Description of Related Art

With the development of automotive intelligence, the number of electrical devices such as vehicle sensors, actuators, and controllers has increased dramatically. Currently, for new energy vehicles, a primary method involves utilizing low-voltage storage battery of the vehicles to provide low-voltage power supply to onboard controllers, sensors, and actuators. However, the method is highly prone to causing a phenomenon of power depletion of the low-voltage storage battery, thereby affecting a normal operation of the vehicle.

Currently, to address the problem of the power depletion of the low-voltage storage battery, a recharge time is calculated primarily based on a voltage of the low-voltage storage battery combined with temperature information of the low-voltage storage battery, and then recharging is performed for the low-voltage storage battery at the recharge time. Although this method saves a certain amount of vehicle costs to some extent, it still has significant limitations. Specifically, this solution requires a large amount of experimental calibration work to optimize a calculation strategy for the recharge time, which increases costs and time of research. Moreover, due to the limited calculation accuracy of the recharge time, there may be situations where the recharge timing is incorrect, causing increasing of the high-voltage energy consumption of the vehicle and energy waste.

### SUMMARY

One of objectives of the present application is to provide a method, system, apparatus for battery charging, a vehicle, an electronic device, and a storage medium, which may reasonably charge the low-voltage storage battery and avoid a waste of high-voltage energy consumption.

To achieve the above objective, technical solutions adopted in the present application are as follows.

According to a first aspect provided in the present application, a method for battery charging is provided, which is applied to a server and includes: receiving operational information of low-voltage devices and a current state of a vehicle from the vehicle; where the low-voltage devices include a low-voltage storage battery and a direct current (DC) conversion device; determining whether the low-voltage storage battery requires charging based on the operational information of the low-voltage devices and the current state of the vehicle; and when determining that the low-voltage storage battery requires charging, sending a high-voltage power-on instruction to the vehicle to enable the vehicle to charge the low-voltage storage battery via the DC conversion device.

Based on the above technical means, the present application may determine whether the low-voltage storage battery requires charging by combining the operational information of the low-voltage devices with the current state of the vehicle, rather than performing charging blindly, which enables charging control more rational and precise, thereby avoiding unnecessary charging operations, optimizing charging timing and energy utilization efficiency, and extending a service life of low-voltage storage battery. Furthermore, only when it is determined that the low-voltage storage battery requires charging, a high-voltage power-on instruction is sent to the vehicle, which enables the vehicle to charge the low-voltage storage battery via the DC conversion device, thereby reasonably utilizing the vehicle's high-voltage system resources, and also reducing a need of manual intervention as well as improving users' experience.

In one possible implementation, the determining whether the low-voltage storage battery requires charging based on the operational information of the low-voltage devices and the current state of the vehicle includes: determining whether the low-voltage storage battery requires charging based on the current state of the vehicle and energy information of the low-voltage storage battery; where the energy information of the low-voltage storage battery includes remaining discharging duration of the low-voltage storage battery and/or a voltage of the low-voltage storage battery.

Based on the above technical means, the present application may determine the charging requirements of the low-voltage storage battery precisely by comprehensively considering the current state of the vehicle and the energy information of the low-voltage storage battery, which enables triggering the high-voltage power-on instruction only when both the energy information of the low-voltage storage battery and the state of the vehicle meet the conditions, thereby avoiding energy waste of the vehicle.

In one possible implementation, the determining whether the low-voltage storage battery requires charging based on the current state of the vehicle and the energy information of the low-voltage storage battery includes: when the current state of the vehicle is a wake-up state, if the voltage of the low-voltage storage battery is less than or equal to a voltage threshold, and/or the remaining discharging duration of the low-voltage storage battery is less than or equal to a discharging duration threshold, determining that the low-voltage storage battery requires charging; and if the voltage of the low-voltage storage battery is greater than the voltage threshold, and/or the remaining discharging duration of the low-voltage storage battery is greater than the discharging duration threshold, determining that the low-voltage storage battery does not require charging.

Based on the above technical means, the present application may promptly initiate charging when the voltage of the low-voltage storage battery is too low or the remaining discharging duration is insufficient, which ensures the normal operation of the low-voltage storage battery and prevents power depletion failures.

In one possible implementation, the determining whether the low-voltage storage battery requires charging based on the current state of the vehicle and the energy information of the low-voltage storage battery includes: when the current state of the vehicle is a dormant state, if the remaining discharging duration of the low-voltage storage battery is less than or equal to a discharging duration threshold, determining that the low-voltage storage battery requires charging; and if the remaining discharging duration of the low-voltage storage battery is greater than the discharging duration threshold, determining that the low-voltage storage battery does not require charging.

In one possible implementation, the method further includes: acquiring target energy consumption compensation parameters corresponding to the voltage of the low-voltage storage battery and a current ambient temperature of the vehicle; and determining the remaining discharging duration of the low-voltage storage battery based on the operational information of the low-voltage devices, a current operating state of the vehicle, and the target energy consumption compensation parameters.

Based on the above technical means, by acquiring the target energy consumption compensation parameters corresponding to the voltage of the low-voltage storage battery and the current ambient temperature of the vehicle, the present application may fully take an influence of environmental factors and a battery's own state on energy consumption into account. On this basis, by combining the operational information of the low-voltage devices and the current operating state of the vehicle, the accuracy of estimating remaining discharging duration may be improved.

In one possible implementation, the low-voltage devices further include low-voltage electrical devices. On this basis, the determining the remaining discharging duration of the low-voltage storage battery based on the operational information of the low-voltage devices, the current operating state of the vehicle, and the target energy consumption compensation parameters includes: determining a current remaining energy of the low-voltage storage battery based on the voltage of the low-voltage storage battery, an output power and an operating state of the DC conversion device, energy consumption power of the low-voltage electrical devices, and the target energy consumption compensation parameters; and determining the remaining discharging duration of the low-voltage storage battery based on the current operating state of the vehicle and the current remaining energy of the low-voltage storage battery.

Based on the above technical means, the present application comprehensively considers key factors such as the voltage of the low-voltage storage battery, the output power and the operating state of the DC conversion devices, the energy consumption power of the low-voltage electrical devices, and target energy consumption compensation parameters, which enables more precise determination of the current remaining energy of the low-voltage storage battery, providing a reliable data foundation for subsequent system management and decision-making. Furthermore, by combining the current state of the vehicle with the remaining energy of the low-voltage storage battery that is precisely calculated, a more realistic remaining discharging duration may be derived.

In one possible implementation, the determining the remaining discharging duration of the low-voltage storage battery based on the current operating state of the vehicle and the current remaining energy of the low-voltage storage battery includes: when the current state of the vehicle is a wake-up state, determining target energy consumption power of the low-voltage electrical devices based on the energy consumption power of the low-voltage electrical devices and the target energy consumption compensation parameters; and determining the remaining discharging duration of the low-voltage storage battery based on the current remaining energy of the low-voltage storage battery and the target energy consumption power of the low-voltage electrical devices.

In one possible implementation, the determining the remaining discharging duration of the low-voltage storage battery based on the current operating state of the vehicle and the current remaining energy of the low-voltage storage battery includes: when the current state of the vehicle is a dormant state, determining a remaining energy of the low-voltage storage battery when the vehicle enters the dormant state and a remaining energy of the low-voltage storage battery when the vehicle exits the dormant state; determining a dark current energy consumption power of the low-voltage storage battery based on the remaining energy of the low-voltage storage battery when the vehicle enters the dormant state and the remaining energy of the low-voltage storage battery when the vehicle exits the dormant state; where the dark current energy consumption power refers to a current consumption present in the low-voltage storage battery after the vehicle enters the dormant state; and determining the remaining discharging duration of the low-voltage storage battery based on the dark current energy consumption power and the current remaining energy of the low-voltage storage battery.

Based on the above technical means, the present application determines the remaining energy of the low-voltage storage battery when the vehicle enters the dormant state and the remaining energy the low-voltage storage battery when the vehicle exits the dormant state, and further calculates the dark current energy consumption power, which enables assessing energy loss of the low-voltage storage battery during a dormant period accurately, thereby holding a significant importance for optimizing electrical system design of the vehicle and reducing energy consumption during the dormant period.

In one possible implementation, the method further includes: determining multiple dark current energy consumption powers of the low-voltage storage battery within a first preset time interval; where the dark current energy consumption power refers to an energy consumed by the low-voltage storage battery after the vehicle enters the dormant state; and if the number of a target dark current energy consumption power among the multiple dark current energy consumption powers is greater than a first quantity threshold, outputting a message of dark current abnormity; where a value of the target dark current energy consumption power is greater than an energy consumption threshold.

Based on the above technical means, the present application determines multiple dark current power consumption powers of the low-voltage storage battery over a first preset time interval and compares them with a power consumption threshold, which enable detecting whether a low-voltage storage battery exhibits abnormal power consumption promptly. When the number of the dark current power consumption powers exceeding the consumption threshold is greater than a first quantity threshold, a message of dark current abnormity is output, which enables users or maintenance personnel of the vehicle to promptly identify the abnormal condition of the battery, allowing them to take corresponding measures to prevent issues such as vehicle failure to start or battery damage caused by excessive power consumption of the battery.

In one possible implementation, the method further includes: acquiring multiple charge-discharge parameters corresponding to the voltage of the low-voltage storage battery and the ambient temperature of the vehicle within a second preset time interval; where the charge-discharge parameters are used to evaluate a life status of the low-voltage storage battery; and if the number of a target charge-discharge parameter among the multiple charge-discharge parameters is greater than a second quantity threshold, outputting a health warning message of the low-voltage storage battery; where a value of the target charge-discharge parameter is less than a discharge parameter threshold.

Based on the above technical methods, the present application may assess an actual lifespan status of a battery comprehensively and accurately based on the charge-discharge parameters, which enables detecting battery health issues early and taking corresponding measures, thereby extending a service life of the battery.

According to a second aspect provided in the present application, a method for battery charging is provided, which is applied to a vehicle and includes: sending operational information of low-voltage devices and a current state of a vehicle to a server, so that the server determines whether the low-voltage storage battery requires charging based on the operational information of the low-voltage devices and the current state of the vehicle; where the low-voltage devices include the low-voltage storage battery and a DC conversion device; receiving a high-voltage power-on instruction sent by the server; where the high-voltage power-on instruction is sent by the server when determining that the low-voltage storage battery requires charging; and in response to the high-voltage power-on instruction, charging the low-voltage storage battery via the DC conversion device.

Based on the above technical means, the present application may send operational information of the low-voltage devices and the current state of the vehicle to the server, which enables the server to evaluate multiple factors comprehensively to determine whether the low-voltage storage battery requires charging. When the server determines that the low-voltage storage battery requires charging and sends a high-voltage power-on instruction, the vehicle may, in response to the high-voltage power-on instruction, charge the low-voltage storage battery via the DC conversion device, which may ensure that the energy of the low-voltage storage battery remains at an appropriate level, and guarantee a stable operation of the electrical system of the vehicle.

In one possible implementation, the method further includes: when detecting that it is impossible to communicate with the server, determining whether the low-voltage storage battery requires charging based on the operational information of the low-voltage devices and the current state of the vehicle; and charging the low-voltage storage battery via the DC conversion device when determining that the low-voltage storage battery requires charging.

Based on the above technical means, when detecting that it is impossible to communicate with the server, the present application enables the vehicle to independently determine whether the low-voltage storage battery requires charging based on the operational information of the vehicle's own low-voltage devices and the current state of the vehicle. This ensures that the vehicle may still maintain a normal operation of the charging function even in an event of communication failure, avoiding a situation where the low-voltage storage battery cannot be charged due to the inability to communicate with the server, and thus guarantees the autonomy and stability of the vehicle's energy supply.

In one possible implementation, the determining whether the low-voltage storage battery requires charging based on the operational information of the low-voltage devices and the current state of the vehicle includes: determining whether the low-voltage storage battery requires charging based on the current state of the vehicle and energy information of the low-voltage storage battery; where the energy information of the low-voltage storage battery includes remaining discharging duration of the low-voltage storage battery and/or a voltage of the low-voltage storage battery.

In one possible implementation, the determining whether the low-voltage storage battery requires charging based on the current state of the vehicle and the energy information of the low-voltage storage battery includes: when the current state of the vehicle is a wake-up state, if the voltage of the low-voltage storage battery is less than or equal to a voltage threshold, and/or the remaining discharging duration of the low-voltage storage battery is less than or equal to a discharging duration threshold, determining that the low-voltage storage battery requires charging; if the voltage of the low-voltage storage battery is greater than the voltage threshold, and/or the remaining discharging duration of the low-voltage storage battery is greater than the discharging duration threshold, determining that the low-voltage storage battery does not require charging.

In one possible implementation, the determining whether the low-voltage storage battery requires charging based on the current state of the vehicle and the energy information of the low-voltage storage battery includes: when the current state of the vehicle is a dormant state, if the remaining discharging duration of the low-voltage storage battery is less than or equal to a discharging duration threshold, determining that the low-voltage storage battery requires charging; and if the remaining discharging duration of the low-voltage storage battery is greater than the discharging duration threshold, determining that the low-voltage storage battery does not require charging.

In one possible implementation, the low-voltage devices further include a low-voltage electrical device. On this basis, the method further includes: determining energy consumption power of the low-voltage electrical device based on current and voltage of the low-voltage electrical device.

According to a third aspect provided in the present application, a system for battery charging is provided, including a vehicle and a server.

Where the server is configured to perform the method described in the first aspect and any possible implementation thereof, and the vehicle is configured to perform the method described in the second aspect and any possible implementation thereof.

According to a fourth aspect provided in the present application, an apparatus for battery charging is provided, which is applied to a server and includes: a communication unit and a determination unit. The communication unit is configured to receive operational information of low-voltage devices and a current state of a vehicle from the vehicle; where the low-voltage devices include a low-voltage storage battery and a DC conversion device. The determination unit is configured to determine whether the low-voltage storage battery requires charging based on the operational information of low-voltage devices and the current state of the vehicle. The communication unit is further configured to send a high-voltage power-on instruction to the vehicle when determining that the low-voltage storage battery requires charging, to enable the vehicle to charge the low-voltage storage battery via the DC conversion device.

In one possible implementation, the determination unit is further configured to, determine whether the low-voltage storage battery requires charging based on the current state of the vehicle and the energy information of the low-voltage storage battery.

In one possible implementation, the determination unit is further configured to, when the current state of the vehicle is a wake-up state, if the voltage of the low-voltage storage battery is less than or equal to a voltage threshold, and/or the remaining discharging duration of the low-voltage storage battery is less than or equal to a discharging duration threshold, determine that the low-voltage storage battery requires charging; and if the voltage of the low-voltage storage battery is greater than the voltage threshold, and/or the remaining discharging duration of the low-voltage storage battery is greater than the discharging duration threshold, determine that the low-voltage storage battery does not require charging.

In one possible implementation, the determination unit is further configured to, when the current state of the vehicle is a dormant state, if the remaining discharging duration of the low-voltage storage battery is less than or equal to a discharging duration threshold, determine that the low-voltage storage battery requires charging; and if the remaining discharging duration of the low-voltage storage battery is greater than the discharging duration threshold, determine that the low-voltage storage battery does not require charging.

In one possible implementation, the determination unit is further configured to, determine the remaining discharging duration of the low-voltage storage battery based on the operational information of the low-voltage devices, a current operating state of the vehicle, and the target energy consumption compensation parameters.

In one possible implementation, the determination unit is further configured to, determine a current remaining energy of the low-voltage storage battery based on the voltage of the low-voltage storage battery, an output power and an operating state of the DC conversion device, energy consumption power of the low-voltage electrical devices, and the target energy consumption compensation parameters.

In one possible implementation, the determination unit is further configured to, determine the remaining discharging duration of the low-voltage storage battery based on the current operating state of the vehicle and the current remaining energy of the low-voltage storage battery.

In one possible implementation, the determination unit is further configured to, when the current state of the vehicle is a wake-up state, determine target energy consumption power of the low-voltage electrical devices based on the energy consumption power of the low-voltage electrical devices and the target energy consumption compensation parameters.

In one possible implementation, the determination unit is further configured to, determine the remaining discharging duration of the low-voltage storage battery based on the current remaining energy of the low-voltage storage battery and the target energy consumption power of the low-voltage electrical devices.

In one possible implementation, the determination unit is further configured to, when the current state of the vehicle is a dormant state, determine a remaining energy of the low-voltage storage battery when the vehicle enters the dormant state and a remaining energy of the low-voltage storage battery when the vehicle exits the dormant state.

In one possible implementation, the determination unit is further configured to, determine a dark current energy consumption power of the low-voltage storage battery based on the remaining energy of the low-voltage storage battery when the vehicle enters the dormant state and the remaining energy of the low-voltage storage battery when the vehicle exits the dormant state.

In one possible implementation, the determination unit is further configured to, determine the remaining discharging duration of the low-voltage storage battery based on the dark current energy consumption power and the current remaining energy of the low-voltage storage battery.

According to a fifth aspect provided in the present application, an apparatus for battery charging is provided, which is applied to a vehicle and includes: a transceiving unit and a response unit.

The transceiving unit is configured to send operational information of low-voltage devices and a current state of a vehicle to a server, so that the server determines whether the low-voltage storage battery requires charging based on the operational information of the low-voltage devices and the current state of the vehicle; where the low-voltage devices include the low-voltage storage battery and a DC conversion device.

The transceiving unit is further configured to receive a high-voltage power-on instruction sent by the server; where the high-voltage power-on instruction is sent by the server when determining that the low-voltage storage battery requires charging.

The response unit is configured to charge the low-voltage storage battery via the DC conversion device in response to the high-voltage power-on instruction.

According to a sixth aspect provided in the present application, a vehicle is provided, where the vehicle is configured to perform the method described in the second aspect and any possible implementation thereof.

According to a seventh aspect provided in the present application, an electronic device is provided, including: a processor and a memory for storing instructions executable by the processor. Where the processor is configured to execute the instructions to implement the method described in the first aspect and any possible implementation thereof, or the method described in the second aspect and any possible implementation thereof.

According to an eighth aspect provided in the present application, a computer readable storage medium is provided. When instructions in the computer-readable storage medium are executed by a processor of an electronic device, the electronic device is enabled to execute the method described in the first aspect and any possible implementation thereof, or execute the method described in the second aspect and any possible implementation thereof.

According to a ninth aspect provided in the present application, a computer program product is provided, where the computer program product includes computer instructions which, when run in an electronic device, enable the electronic device to execute the method described in the first aspect and any possible implementation thereof, or execute the method described in the second aspect and any possible implementation thereof.

Thus, the above technical features of the present application provide the following beneficial effects.
(1) It determines whether the low-voltage storage battery requires charging by combining the operational information of the low-voltage devices with the current state of the vehicle, rather than performing charging blindly, which enables charging control more rational and precise, thereby avoiding unnecessary charging operations, optimizing charging timing and energy utilization efficiency, and extending a service life of low-voltage storage battery. Furthermore, only when it is determined that the low-voltage storage battery requires charging, a high-voltage power-on instruction is sent to the vehicle, which enables the vehicle to charge the low-voltage storage battery via the DC conversion device, thereby reasonably utilizing the vehicle's high-voltage system resources, and also reducing a need of manual intervention as well as improving users' experience.
(2) It may determine the charging requirements of the low-voltage storage battery precisely by comprehensively considering the current state of the vehicle and the energy information of the low-voltage storage battery, which enables triggering the high-voltage power-on instruction only when both the energy information of the low-voltage storage battery and the state of the vehicle meet the conditions, thereby avoiding energy waste of the vehicle.
(3) It may promptly initiate charging when the voltage of the low-voltage storage battery is too low or the remaining discharging duration is insufficient, which ensures the normal operation of the low-voltage storage battery and prevents power depletion failures.
(4) By acquiring the target energy consumption compensation parameters corresponding to the voltage of the low-voltage storage battery and the current ambient temperature of the vehicle, it may fully take an influence of environmental factors and a battery's own state on energy consumption into account. On this basis, by combining the operational information of the low-voltage devices and the current operating state of the vehicle, the accuracy of estimating remaining discharging duration may be improved.
(5) It comprehensively considers key factors such as the voltage of the low-voltage storage battery, the output power and the operating state of the DC conversion devices, the energy consumption power of the low-voltage electrical devices, and target energy consumption compensation parameters, which enables more precise determination of the current remaining energy of the low-voltage storage battery, providing a reliable data foundation for subsequent system management and decision-making. Furthermore, by combining the current state of the vehicle with the remaining energy of the low-voltage storage battery that is precisely calculated, a more realistic remaining discharging duration may be derived.
(6) It determines the remaining energy of the low-voltage storage battery when the vehicle enters the dormant state and the remaining energy the low-voltage storage battery when the vehicle exits the dormant state, and further calculates the dark current energy consumption power, which enables assessing energy loss of the low-voltage storage battery during a dormant period accurately, thereby holding a significant importance for optimizing electrical system design of the vehicle and reducing energy consumption during the dormant period.
(7) It determines multiple dark current power consumption powers of the low-voltage storage battery over a first preset time interval and compares them with a power consumption threshold, which enable detecting whether a low-voltage storage battery exhibits abnormal power consumption promptly. When the number of the dark current power consumption powers exceeding the consumption threshold is greater than a first quantity threshold, a message of dark current abnormity is output, which enables users or maintenance personnel of the vehicle to promptly identify the abnormal condition of the battery, allowing them to take corresponding measures to prevent issues such as vehicle failure to start or battery damage caused by excessive power consumption of the battery.
(8) It may assess an actual lifespan status of a battery comprehensively and accurately based on the charge-discharge parameters, which enables detecting battery health issues early and taking corresponding measures, thereby extending a service life of the battery.
(9) It may send operational information of the low-voltage devices and the current state of the vehicle to the server, which enables the server to evaluate multiple factors comprehensively to determine whether the low-voltage storage battery requires charging. When the server determines that the low-voltage storage battery requires charging and sends a high-voltage power-on instruction, the vehicle may, in response to the high-voltage power-on instruction, charge the low-voltage storage battery via the DC conversion device, which may ensure that the energy of the low-voltage storage battery remains at an appropriate level, and guarantee a stable operation of the electrical system of the vehicle.
(10) It enables the vehicle to independently determine whether the low-voltage storage battery requires charging based on the operational information of the vehicle's own low-voltage devices and the current state of the vehicle. This ensures that the vehicle may still maintain a normal operation of the charging function even in an event of communication failure, avoiding a situation where the low-voltage storage battery cannot be charged due to the inability to communicate with the server, and thus guarantees the autonomy and stability of the vehicle's energy supply.

It should be noted that the technical effects achieved by any one of the implementations in the third aspect to the ninth aspect may refer to the technical effects achieved by the corresponding implementations in the first aspect or the second aspect, which are not repeated here.

It should be understood that the above general description and the subsequent detailed description are merely illustrative and explanatory, and do not limit the present application.

### BRIEF DESCRIPTION OF DRAWINGS

FIG. 1 is a diagram of an architecture of a system for battery charging provided by an embodiment of the present application.

FIGS. 2A and 2B are diagrams of an architecture of another system for battery charging provided by an embodiment of the present application.

FIG. 3 is a flowchart of a method for battery charging provided by an embodiment of the present application.

FIG. 4 is a flowchart of another method for battery charging provided by an embodiment of the present application.

FIG. 5 is a curve diagram of operating parameters of a low-voltage device provided by an embodiment of the present application.

FIG. 6 is a flowchart of constructing a charge-discharge parameter Map of a low-voltage storage battery provided by an embodiment of the present application.

FIG. 7 is a schematic diagram of a cure of operating parameters of another low-voltage device provided by an embodiment of the present application.

FIG. 8 is a flowchart of constructing a low-voltage energy consumption compensation parameter Map provided by an embodiment of the present application.

FIG. 9 is a schematic diagram of a classification of a low-voltage electrical device provided by an embodiment of the present application.

FIG. 10 is a flowchart of another method for battery charging provided by an embodiment of the present application.

FIG. 11 is a block diagram of an apparatus for battery charging provided by an embodiment of the present application.

FIG. 12 is a block diagram of another apparatus for battery charging provided by an embodiment of the present application.

FIG. 13 is a block diagram of an electronic device provided by an embodiment of the present application.

### DESCRIPTION OF EMBODIMENTS

To enable those of ordinary skill in the art to better understand the technical solutions of the present application, the technical solutions in the embodiments of the present application will be described clearly and completely below with reference to the accompanying drawings.

It should be noted that the terms such as “first,” “second,” and so on, used in the specification, the claims, and the accompanying drawings of the present application are intended to distinguish similar objects and are not necessarily intended to describe a specific sequence or order. It should be understood that the data used in this way may be interchanged as appropriate, such that the embodiments of the present application described herein may be implemented in an order other than that illustrated or described herein. The implementations described in the following exemplary embodiments do not represent all implementations consistent with the present application. Rather, they are merely examples of apparatuses and methods consistent with some aspects of the present application as detailed in the appended claims.

In the embodiments of the present application, terms such as “exemplary”, “such as”, or “for example” are used to indicate examples, illustrations, or explanations. Any embodiment or design described as “exemplary”, “such as”, or “for example” in the embodiments of the present application should not be interpreted as being more preferred or advantageous than other embodiments or designs. Specifically, the use of terms such as “exemplary”, “such as”, or “for example” is intended to present the relevant concepts in a concrete manner.

First, the relevant technology involved in the present application is explained to facilitate understanding by those skilled in the art.

With a rapid advancement of automotive intelligent technologies, the number and variety of functional modules installed in vehicles continue to grow, leading to a sharp increase in the number of electrical devices such as vehicle sensors and actuators. After the vehicle is powered off, although the main power system is deactivated, certain functions such as updating over-the-air (OTA) and mobile remote control still need to continue operating. The operation of these functions will involve a coordinated work of various controllers, actuators, sensors and other electrical devices, thereby resulting in a significant low-voltage energy consumption. For new energy vehicles, a common solution adopted by the current automotive industry is to use the low-voltage storage battery of the vehicle to supply low-voltage power to various on-board controllers, sensors and actuators after the vehicle is powered off. However, this solution is highly prone to causing the low-voltage storage battery to experience power depletion, thereby affecting a normal startup and a functional operation of the vehicle.

At present, the solutions for of power depletion of low-voltage storage battery mainly fall into two categories: Solution 1 is a charging solution based on intelligent battery sensor (IBS), and Solution 2 is a charging solution based on information such as the voltage and temperature of the low-voltage storage battery.

Among these, Solution 1 primarily calculates the remaining energy and the discharging duration of the low-voltage storage battery based on real-time monitoring information of the low-voltage storage battery such as voltage and current from the IBS. When detecting that the energy of the low-voltage storage battery is low, it enables automatically control the vehicle to activate the high-voltage system and charge the low-voltage storage battery through DCDC, thereby effectively avoiding a problem of power depletion of the vehicle. However, a cost of IBS hardware is relatively high, which leads to a fact that most new energy vehicles are not equipped with the hardware.

Solution 2 primarily targets new energy vehicles without IBS hardware. This solution calculates a charging time and a charging duration based on the voltage of the low-voltage storage battery combined with temperature and other information. Subsequently, the vehicle may be awakened at a charging time and be controlled to activate the high-voltage system to charge the low-voltage storage battery via a direct current to direct current converter (DCDC). Although this solution reduces overall costs of the vehicle to some extent, it still has significant limitations. Specifically, due to the lack of precise monitoring methods for the condition of low-voltage storage battery, it is impossible to accurately predict the actual energy and the remaining discharging duration of the low-voltage storage battery, which may lead to charging too early or too late. Secondly, to optimize the charging time and calculation strategy for charging duration, a large amount of experimental calibration work is required, which increases the cost and time of research and development. Furthermore, the limited accuracy in calculating recharging timing and duration may result in inaccurate recharging timing, thereby increasing the high-voltage energy consumption of the vehicle, causing energy waste, and negatively impacting the users' experience.

Therefore, there is an urgent need to develop a more efficient and accurate solution to reduce costs while enhancing the accuracy of low-voltage storage battery condition monitoring and the rationality of charging strategies, thereby lowering the energy consumption of the vehicle and improving the users' experience.

To address the above technical problems, the present application provides a method for battery charging, which may determine whether the low-voltage storage battery requires charging by combining the operational information of the low-voltage devices with the current state of the vehicle, rather than performing charging blindly, which enables charging control more rational and precise, thereby avoiding unnecessary charging operations, optimizing charging timing and energy utilization efficiency, and extending a service life of low-voltage storage battery. Furthermore, only when it is determined that the low-voltage storage battery requires charging, a high-voltage power-on instruction is sent to the vehicle, which enables the vehicle to charge the low-voltage storage battery via its DC conversion device, thereby efficiently utilizing the vehicle's high-voltage system resources, and also reducing a need for manual intervention and improving user's experience.

The following will describe the technical solutions of the embodiments of the present application in combination with the accompanying drawings in the embodiments of the present application. Obviously, the described embodiments are only part of the embodiments of the present application, not all of them.

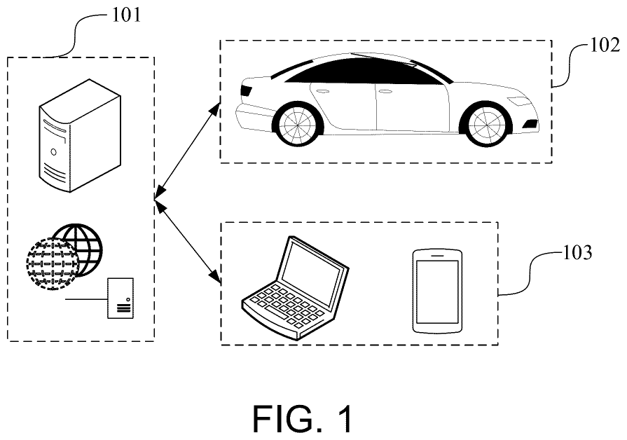

FIG. 1 is a diagram of an architecture of a system for battery charging provided by an embodiment of the present application. As shown in FIG. 1, the architecture of the system includes: a server 101, a vehicle 102, and a terminal device 103. The server 101, the vehicle 102, and the terminal device 103 are interconnected via a communication way.

Among these, the server 101 may be a high-performance server providing various services on the Internet, or an independent physical server, or a server cluster composed of multiple physical servers, or at least one of cloud server offering fundamental cloud computing services such as cloud services, cloud databases, cloud computing, cloud functions, cloud storage, network services, cloud communications, middleware services, domain name services, security services, content delivery networks, and big data or artificial intelligence platforms. The embodiments of the present application do not impose limitations in this regard. Of course, the server may also incorporate additional functionalities to deliver more comprehensive and diversified services.

The server 101 in the embodiments of the present application may be a single server, or a server cluster, or a cloud server, which is not limited in the embodiments of the present application.

The vehicle 102 may be a car, a sport utility vehicle (sport utility vehicle, SUV), a truck, an electric vehicle, a motorcycle, a tricycle, a special-purpose vehicle (e.g., an ambulance, a fire truck, a police car), an autonomous taxi, a smart connected bus, an autonomous logistics vehicle, an electric van, etc. Furthermore, this method is applicable to various specialized vehicles, such as agricultural vehicles, mining vehicles, forestry vehicles, airport vehicles, port vehicles, etc., which is not limited in the embodiments of the present application. In the embodiments of the present application, the vehicle 102 may be referred to as a means of transportation (vehicle), a mobile carrier, an electric vehicle (EV), a hybrid electric vehicle (HEV), a plug-in hybrid electric vehicle (PHEV), a fuel cell vehicle (FCV), an autonomous vehicle, an intelligent and connected vehicle (ICV), or a driverless vehicle, etc., there is no limitation on this.

The terminal device 103 may be a device providing voice and/or data connectivity to users, a device with unlimited connectivity capabilities, or other devices connected to a wireless modem. The terminal device 103 may be at least one of a mobile phone, a desktop computer, a laptop computer, a wireless terminal, a notebook computer, etc. In one embodiment, the terminal device 103 has communication capabilities enabling access to wired or wireless networks.

The number of the terminal device 103 in the system for battery charging according to the embodiments of the present application is not limited and may include more or fewer terminal devices 103 than that shown in FIG. 1.

In the embodiments of the present application, the vehicle 102 may send operational information of the low-voltage device and the current state of the vehicle to the server 101. Correspondingly, the server 101 may determine whether the low-voltage storage battery requires charging based on the operational information of the low-voltage device and the current state of the vehicle sent by the vehicle 102, and send a high-voltage power-on instruction to the vehicle 102 when determining the low-voltage storage battery requires charging. Correspondingly, the vehicle 102 may charge the low-voltage storage battery via the DC conversion device in response to the high-voltage power-on instruction.

In one possible implementation, the server 101 may determine multiple dark current energy consumption powers of the low-voltage storage battery within a first preset time interval. When the number of dark current energy consumption power with the values thereof exceeding the energy consumption threshold among the multiple dark current energy consumption powers is greater than the first quantity threshold, the server 101 sends a message of dark current abnormity to the vehicle 102 and the terminal device 103. Correspondingly, the user may view the message of dark current abnormity on a dashboard of the vehicle 102. Users holding the terminal device 103 may view the message of dark current abnormity on the application installed in the terminal device 103.

In one possible implementation, the server 101 may acquire multiple charge-discharge parameters corresponding to the voltage of the low-voltage storage battery and the ambient temperature of the vehicle within a second preset time interval. When the number of charge-discharge parameters exceeding the discharge parameter threshold among multiple charge-discharge parameters is greater than a second quantity threshold, the server 101 sends a health warning message of the low-voltage storage battery to the vehicle 102 and the terminal device 103. Correspondingly, the user may view the health warning message of the low-voltage storage battery on the dashboard of the vehicle 102. Users holding the terminal device 103 may view the health warning message of the low-voltage storage battery on the application installed in the terminal device 103.

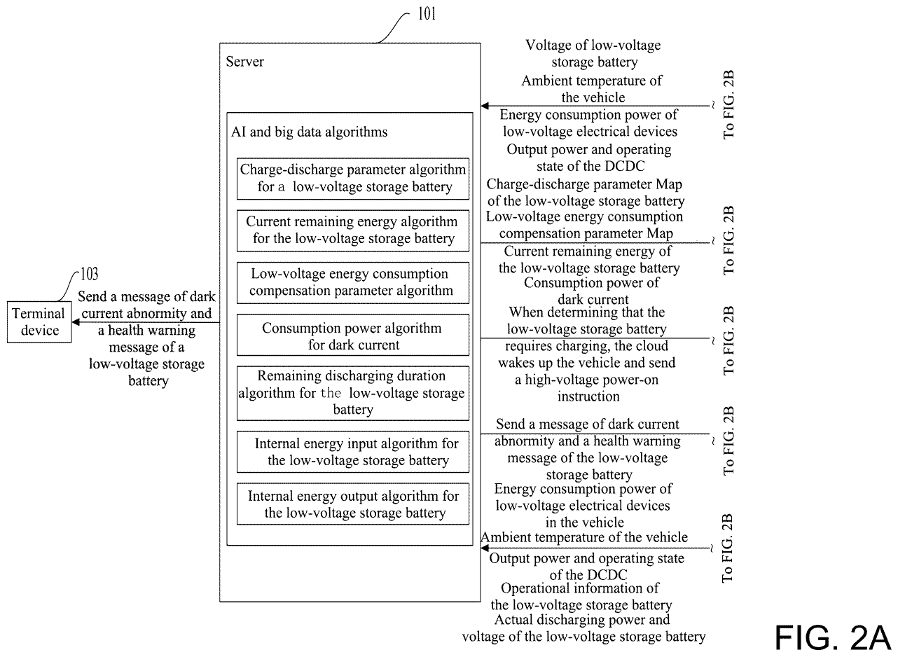

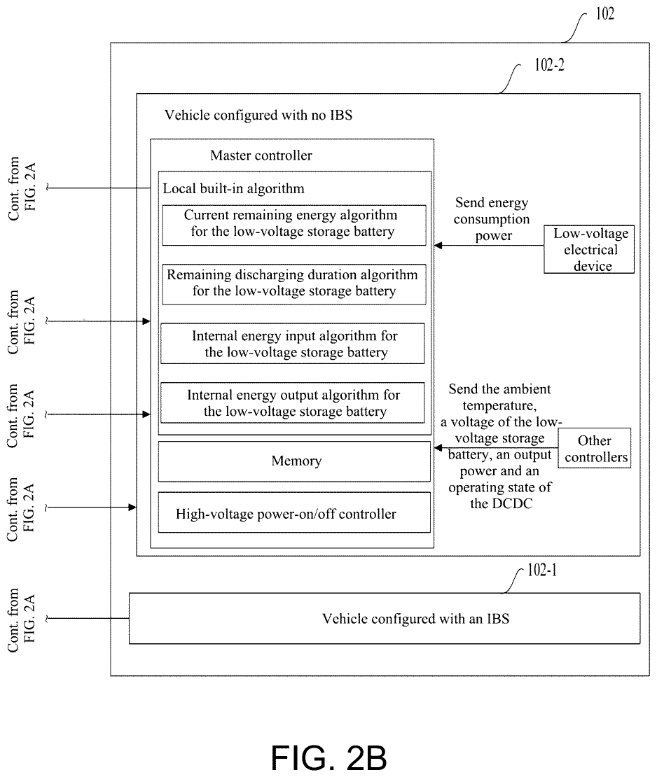

In one example, as shown in FIGS. 2A and 2B, the server 101 is configured with artificial intelligence (AI) and big data algorithms. The AI and big data algorithms may include: a charge-discharge parameter algorithm for a low-voltage storage battery, a current remaining energy algorithm for a low-voltage storage battery, a low-voltage energy consumption compensation parameter algorithm, a consumption power algorithm for dark current, a remaining discharging duration algorithm for a low-voltage storage battery, an internal energy input algorithm for a low-voltage storage battery, an internal energy output algorithm for a low-voltage storage battery.

Where, the charge-discharge parameter algorithm for the low-voltage storage battery is used to determine the charge-discharge parameters of the low-voltage storage battery and construct a Map with the voltage of the low-voltage storage battery and the ambient temperature of the vehicle as the input and the charge-discharge parameter as the output, that is, a correspondence between the voltage of the low-voltage storage battery, the ambient temperature of the vehicle, and the charge-discharge parameters.

The low-voltage energy consumption compensation parameter algorithm is used to determine the low-voltage energy consumption compensation parameter (also known as an energy consumption compensation parameter) of the low-voltage electrical devices of the vehicle, and construct a Map with the voltage of the low-voltage storage battery and the ambient temperature of the vehicle as the input and the low-voltage energy consumption compensation parameter as the output, that is, a correspondence between the voltage of the low-voltage storage battery, the ambient temperature of the vehicle, and the low-voltage energy consumption compensation parameter.

The current remaining energy algorithm for the low-voltage storage battery, is used to determine the current remaining energy of the low-voltage storage battery.

The remaining discharging duration algorithm for the low-voltage storage battery is used to determine the current remaining discharging duration of the low-voltage storage battery.

The consumption power algorithm for dark current is used to determine the current consumption power of the low-voltage storage battery when the vehicle is in a dormant state.

The internal energy input algorithm for low-voltage storage battery is used to determine the energy charged into the low-voltage storage battery by the DCDC during a charging condition. The internal energy output algorithm for low-voltage storage battery is used to determine the energy discharged from the low-voltage storage battery during a discharging condition.

In another example, as shown in FIGS. 2A and 2B, the vehicle 102 may include a vehicle 102-1 configured with an IBS and a vehicle 102-2 configured with no IBS.

The vehicle 102-1 configured with the IBS may send the following data to the server 101: energy consumption power of low-voltage electrical devices in the vehicle, ambient temperature of the vehicle, output power and an operating state of the DCDC, operational information of the low-voltage storage battery, and actual discharging power and voltage of the low-voltage storage battery.

The vehicle 102-2 configured with no IBS may include a master controller, a low-voltage electrical device (also referred to as a sub-controller), and other controllers (such as a temperature sensor, a DCDC, and a low-voltage storage battery). The master controller may include a memory and a high-voltage power-on/power-off controller.

Where, the low-voltage electrical device may send energy consumption power to the master controller, and the main controller may summarize the energy consumption power of each low-voltage electrical device to obtain the energy consumption power of the low-voltage electrical devices of the vehicle. Other controllers may send the ambient temperature, the voltage of the low-voltage storage battery, the output power and the operating state of the DCDC to the master controller. The master controller may send the received voltage of the low-voltage storage battery, the ambient temperature of the vehicle, the energy consumption power of the low-voltage electrical device, the output power and the operating state of the DCDC to the server 101 and store them in the memory.

In one possible implementation, as shown in FIGS. 2A and 2B, the master controller may further be configured with a local built-in algorithm, specifically may include: a current remaining energy algorithm for the low-voltage storage battery, a remaining discharging duration algorithm for the low-voltage storage battery, an internal energy input algorithm for the low-voltage storage battery and an internal energy output algorithm for the low-voltage storage battery. Where, the functionality of each algorithm may refer to the description of the respective algorithms in the above server 101 and is not repeated here.

In the embodiment of the present application, as shown in FIGS. 2A and 2B, the server 101 may send the following data to the master controller in the vehicle 102-2 configured with no IBS: a charge-discharge parameter Map of the low-voltage storage battery, a low-voltage energy consumption compensation parameter Map, current remaining energy of the low-voltage storage battery and consumption power of the dark current. Correspondingly, the master controller may store the received charge-discharge parameter Map of the low-voltage storage battery, low-voltage energy consumption compensation parameter Map, current remaining energy of the low-voltage storage battery and consumption power of the dark current in the memory.

In one possible implementation, as shown in FIGS. 2A and 2B, when the server 101 determines that the low-voltage storage battery requires charging, it may wake up the vehicle via the cloud and send a high-voltage power-on instruction to the master controller. Correspondingly, upon receiving the high-voltage power-on instruction, the master controller may control the vehicle to activate the high-voltage system via the high-voltage power-on/power-off controller and charge the low-voltage storage battery via the DCDC.

In one possible implementation, as shown in FIGS. 2A and 2B, the server 101 may further send a message of dark current abnormity and a health warning message of the low-voltage storage battery to the vehicle 102-2 configured with no IBS and to the terminal device 103. Correspondingly, users may view the message with dark current abnormity and the health warning message of the low-voltage storage battery on the dashboard of the vehicle 102-2 configured with no IBS. Users holding the terminal device 103 may view the message of dark current abnormity and the health warning message of the low-voltage storage battery on the application installed in the terminal device 103.

For ease of understanding, a resource configuration method provided by the present application is described in detail below with reference to the accompanying drawings.

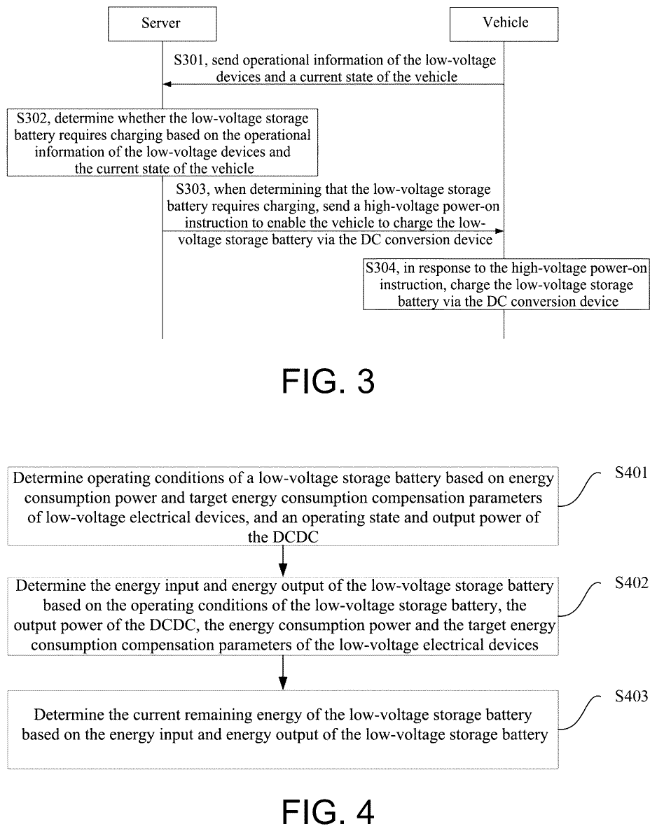

FIG. 3 is a flowchart of a method for battery charging provided by an embodiment of the present application. As shown in FIG. 3, the method includes: S301-S304.

S301, the vehicle sends operational information of the low-voltage devices and a current state of the vehicle to the server. Correspondingly, the server receives the operational information of the low-voltage devices and the current state of the vehicle from the vehicle.

Where, the low-voltage devices may include a low-voltage storage battery, a DC conversion device (hereinafter referred to as DCDC), and low-voltage electrical devices.

In the embodiments of the present application, the operational information of the low-voltage device may include the voltage of the low-voltage storage battery, the energy consumption power of the low-voltage electrical devices, the output power and the operating state of the DCDC, etc., there is no limitation on this.

In one possible implementation, the vehicle may send the voltage of the low-voltage storage battery, the energy consumption power of the low-voltage electrical devices, the output power and the operating state of the DCDC, and the current state of the vehicle to the server in real time. Correspondingly, the server may receive the voltage of the low-voltage storage battery, the energy consumption power of the low-voltage electrical devices, the output power and the operating state of the DCDC, and the current state of the vehicle from the vehicle.

S302, the server determines whether the low-voltage storage battery requires charging based on the operational information of the low-voltage devices and the current state of the vehicle.

In the embodiments of the present application, the server may determine the energy information of the low-voltage storage battery based on the operational information of the low-voltage devices. Subsequently, the server may determine whether the low-voltage storage battery requires charging based on the current state of the vehicle and the energy information of the low-voltage storage battery.

Where, the energy information of the low-voltage storage battery may include the remaining discharging duration and/or the voltage of the low-voltage storage battery.

In one possible implementation, when the current state of the vehicle is a wake-up state, if the voltage of the low-voltage storage battery is less than or equal to a voltage threshold, and/or the remaining discharging duration of the low-voltage storage battery is less than or equal to a discharging duration threshold, the server may determine that the low-voltage storage battery requires charging. If the voltage of the low-voltage storage battery is greater than the voltage threshold, and/or the remaining discharging duration of the low-voltage storage battery is greater than the discharging duration threshold, the server may determine that the low-voltage storage battery does not require charging.

In one possible implementation, the voltage threshold in the embodiments of the present application may be set according to actual requirements. For example, the voltage threshold may be 12.05 volt (V) or 12V, there is no limitation on this.

In another possible implementation, when the current state of the vehicle is a dormant state, if the remaining discharging duration of the low-voltage storage battery is less than or equal to a discharging duration threshold, the server may determine that the low-voltage storage battery requires charging. If the remaining discharging duration of the low-voltage storage battery is greater than the discharging duration threshold, the server may determine that the low-voltage storage battery does not require charging.

S303, when determining that the low-voltage storage battery requires charging, the server sends a high-voltage power-on instruction to the vehicle to enable the vehicle to charge the low-voltage storage battery via the DC conversion device. Correspondingly, the vehicle receives the high-voltage power-on instruction sent by the server.

In one possible implementation, when the current state of the vehicle is a wake-up state, the server may send a high-voltage power-on instruction to the vehicle, to instruct the vehicle to charge the low-voltage storage battery via the DCDC.

In another possible implementation, when the current state of the vehicle is a dormant state, the server may remotely wake the vehicle and send a high-voltage power-on instruction to the vehicle.

S304, in response to the high-voltage power-on instruction, the vehicle charges the low-voltage storage battery via the DC conversion device.

In one possible implementation, upon receiving the high-voltage power-on instruction from the server, the vehicle can activate the DCDC, and then convert the high-voltage direct current from the high-voltage power battery into low-voltage direct current via the DCDC to charge the low-voltage storage battery.

Based on the above technical solution, the present application may determine whether the low-voltage storage battery requires charging accurately by combining the operational information of the low-voltage devices with the current state of the vehicle, rather than performing charging blindly. This way enables charging control more rational and precise, thereby avoiding unnecessary charging operations. Consequently, it not only optimizes charging timing and energy utilization efficiency, but also extends a service life of the low-voltage storage battery. Furthermore, only when it is determined that the low-voltage storage battery requires charging, a high-voltage power-on instruction is sent to the vehicle to enable the vehicle to charge the low-voltage storage battery via the DC conversion device, thereby reasonably utilizing the vehicle's high-voltage system resources, and also reducing a need for manual intervention and improving users' experience.

In some embodiments, the remaining discharging duration of the low-voltage storage battery in the above S302 may be determined as follows.

The server may acquire target energy consumption compensation parameters corresponding to the voltage of the low-voltage storage battery and the current ambient temperature of the vehicle. Subsequently, the server may determine the remaining discharging duration of the low-voltage storage battery based on the operational information of the low-voltage devices, a current operating state of the vehicle, and the target energy consumption compensation parameters.

In one possible implementation, the server stores a correspondence between the voltage and the ambient temperature of the low-voltage storage battery and the energy consumption compensation parameters (hereinafter referred to as the low-voltage energy consumption compensation parameter Map). On this basis, the server may acquire, from the low-voltage energy consumption compensation parameter Map, the target energy consumption compensation parameters corresponding to the current voltage and the current ambient temperature of the low-voltage storage battery. Subsequently, the server may determine the remaining discharging duration of the low-voltage storage battery based on the operational information of the low-voltage devices, the current operating state of the vehicle, and the target energy consumption compensation parameters. Where, the construction method of the low-voltage energy consumption compensation parameter Map may refer to the following embodiments and is not repeated here.

Based on the above technical solution, by acquiring the target energy consumption compensation parameters corresponding to the voltage of the low-voltage storage battery and the current ambient temperature of the vehicle, the present application may fully take an influence of environmental factors and a battery's own state on energy consumption into account. On this basis, by combining the operational information of the low-voltage devices and the current operating state of the vehicle, the accuracy of estimating remaining discharging duration may be improved.

In some embodiments, the server determines the remaining discharging duration of the low-voltage storage battery based on the operational information of the low-voltage devices, the current operating state of the vehicle, and the target energy consumption compensation parameters, including: the server may determine the current remaining energy of the low-voltage storage battery based on the voltage of the low-voltage storage battery, the output power and the operating state of the DC conversion device, the energy consumption power of the low-voltage electrical devices, and the target energy consumption compensation parameters. Subsequently, the server may determine the remaining discharging duration of the low-voltage storage battery based on the current operating state of the vehicle and the current remaining energy of the low-voltage storage battery.

In one possible implementation, when the current state of the vehicle is a wake-up state, the server may determine target energy consumption power of the low-voltage electrical devices based on the energy consumption power of the low-voltage electrical devices and the target energy consumption compensation parameters. Subsequently, the server may determine the remaining discharging duration of the low-voltage storage battery based on the current remaining energy of the low-voltage storage battery and the target energy consumption power of the low-voltage electrical devices. Where, the method for determining the current remaining energy of the low-voltage storage battery may refer to the following embodiments and is not repeated here.

Exemplary, the server may use a product of the energy consumption power of the low-voltage electrical devices and the target energy consumption compensation parameters as the target energy consumption power of the low-voltage electrical devices. Subsequently, the server may use a ratio of the current remaining energy of the low-voltage storage battery to the target energy consumption power of the low-voltage electrical devices as the remaining discharging duration for the low-voltage storage battery. For example, when the current state of the vehicle is a wake-up state, a formula for calculating the remaining discharging duration of the low-voltage storage battery may refer to the following Formula 1.

$$t [ DischrgHld ] = \frac{W [ Batt ]}{P [ Veh ] * Ψ [ Veh ]} * 3600 \qquad ( Formula 1 )$$

Where, W[Batt] represents the current remaining energy of the low-voltage storage battery, measured in watt-hour (Wh), P[Veh] represents the energy consumption power of the low-voltage electrical device, measured in watt (W), Ψ[Veh] represents the target energy consumption compensation parameters, and t[DischrgHld] represents the remaining discharging duration of the low-voltage storage battery.

In another possible implementation, when the current state of the vehicle is a dormant state, the server may determine the remaining energy of the low-voltage storage battery when the vehicle enters the dormant state and the remaining energy of the low-voltage storage battery when the vehicle exits the dormant state. Subsequently, the server may determine a dark current energy consumption power of the low-voltage storage battery based on the remaining energy of the low-voltage storage battery when the vehicle enters the dormant state and the remaining energy of the low-voltage storage battery when the vehicle exits the dormant state. Finally, the server may determine the remaining discharging duration of the low-voltage storage battery based on the dark current energy consumption power and the current remaining energy of the low-voltage storage battery. The method for determining the dark current energy consumption power of the low-voltage storage battery may refer to the following embodiments and is not repeated here.

Where, the dark current energy consumption power refers to the current consumption exists in the low-voltage storage battery after the vehicle enters the dormant state.

Exemplary, the server may use a ratio of the current remaining energy of the low-voltage storage battery to the dark current energy consumption power as the remaining discharging duration of the low-voltage storage battery. For example, when the current state of the vehicle is a dormant state, a formula for calculating the remaining discharging duration of the low-voltage storage battery may refer to the following Formula 2.

$$t [ DischrgHld ] = \frac{W [ Batt ]}{P [ Sleep ]} * 3600 \qquad ( Formula 2 )$$

Where, W[Batt] represents the current remaining energy of the low-voltage storage battery, P[Sleep] represents the dark current energy consumption power of the low-voltage storage battery, measured in W, t[DischrgHld] represents the remaining discharging duration of the low-voltage storage battery.

Based on the above technical means, by comprehensively considering the calculation of the remaining discharging duration of the vehicle in both wake-up and dormant states, the present application may fully grasp the state of the low-voltage storage battery, thereby providing a basis for subsequent determination of whether the low-voltage storage battery requiring charging. Furthermore, in scenarios such as long-term parking of the vehicle, an accurate assessment of remaining discharging duration enables users or maintenance personnel to promptly identify the condition of the battery, which prevents the low-voltage storage battery from damage due to excessive discharging caused by long-term parking, and holds a significant importance for optimizing vehicle electrical system design and reducing energy consumption during the dormant period.

In some embodiments, as shown in FIG. 4, the determining the current remaining energy of the low-voltage storage battery based on the voltage of the low-voltage storage battery, the output power and the operating state of the DC conversion device, the energy consumption power of the low-voltage electrical devices, and the target energy consumption compensation parameters specifically includes S401-S403.

S401, determine operating conditions of a low-voltage storage battery based on energy consumption power and target energy consumption compensation parameters of low-voltage electrical devices, and an operating state and output power of the DCDC.

In the embodiments of the present application, the operating conditions of the low-voltage storage battery may include a charging condition, a discharging condition, and a fully charged condition.

Specifically, when the DCDC is in a non-operating state, the server may determine the operating condition of the low-voltage storage battery to be a discharging condition. When the DCDC is in an operating state, if the output power of the DCDC is less than a product of the energy consumption power of the low-voltage electrical device and the target energy consumption compensation parameters, the server may determine the operating condition of the low-voltage storage battery to be a discharging condition.

When the DCDC is in an operating state, if the output power of the DCDC is greater than the product of the energy consumption power of the low-voltage electrical device and the target energy consumption compensation parameters, the server may determine the operating condition of the low-voltage storage battery to be as a charging condition.

When the output power of the DCDC is equal to the product of the energy consumption power of the low-voltage electrical device and the target energy consumption compensation parameters, the server may determine the operating condition of the low-voltage storage battery to be a fully charged condition.

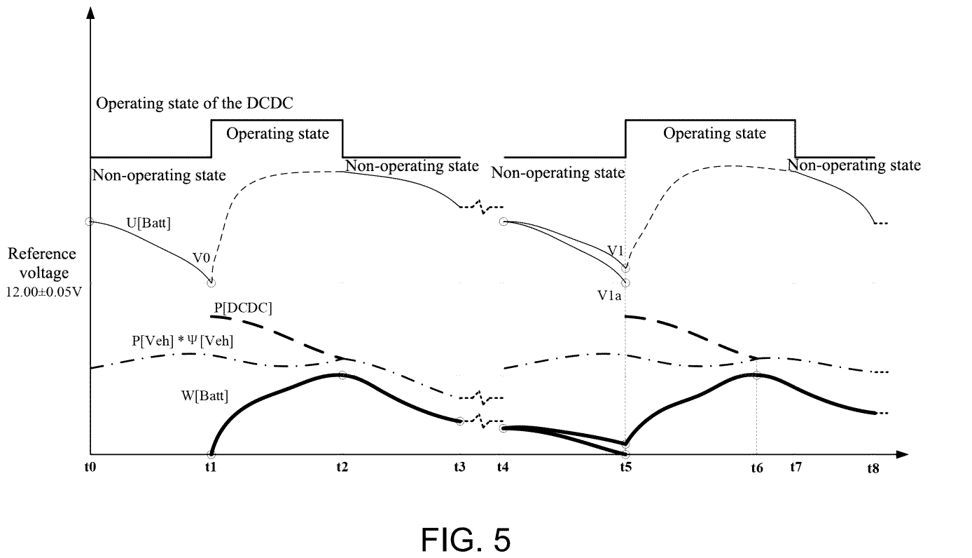

Exemplary, as shown in FIG. 5, combining with the above contents, during time intervals of t1-t2 and t5-t6, the DCDC is in an operating state, and the output power P[DCDC] of the DCDC is greater than the product P[Veh]*Ψ[Veh] of the energy consumption power P[Veh] of the low-voltage electrical device and the target energy consumption compensation parameter Ψ[Veh], then the low-voltage storage battery is in a charging condition during these time intervals of t1-t2 and t5-t6.

During time intervals of t0-t1, t2-t3, t4-t5, and t7-t8, the DCDC is in a non-operating state, indicating that the low-voltage storage battery is in a discharging condition during the time intervals of t0-t1, t2-t3, t4-t5, and t7-t8.

S402, determine the energy input and energy output of the low-voltage storage battery based on the operating conditions of the low-voltage storage battery, the output power of the DCDC, the energy consumption power and the target energy consumption compensation parameters of the low-voltage electrical devices.

In one possible implementation, the server stores a correspondence between the voltage of the low-voltage storage battery, the ambient temperature, and the charge-discharge parameters (hereinafter referred to as the charge-discharge parameter Map of the low-voltage storage battery). On this basis, when the low-voltage storage battery is in a charging condition, the server may determine, from the charge-discharge parameter Map of the low-voltage storage battery, the target charge-discharge parameters corresponding to the voltage of the low-voltage storage battery and the ambient temperature of the vehicle. Subsequently, the server may determine the energy input of the low-voltage storage battery based on the target charge-discharge parameters, the output power of the DCDC, the energy consumption power of the low-voltage electrical device, and the target energy consumption compensation parameters. Where the method for constructing the charge-discharge parameter Map of the low-voltage storage battery may refer to the following embodiments and is not repeated here.

Exemplary, in combination with FIG. 5, taking the time interval of t1-t2 and the operating condition of the low-voltage storage battery being the charging condition as an example, the energy input of the low-voltage storage battery may meet the following formula 3.

$$W [ BattChrg ] = {\int }_{t 1}^{t 2} ( ( P [ DCDC ] - P [ Veh ] * Ψ [ Veh ] ) * t ) * Ψ [ Batt ] \qquad ( Formula 3 )$$

Where, P[DCDC] represents the output power of the DCDC at time t, measured in W, where t is any instant within the time interval of t1-t2. P[Veh] represents the energy consumption power of the low-voltage electrical device at time t. Ψ[Veh] represents the target energy consumption compensation parameter at time t, Ψ[Batt] represents the target charge-discharge parameters at time t. W[BattChrg] represents the energy input of the low-voltage storage battery during the time interval of t1-t2.

In another possible implementation, when the operating condition of the low-voltage storage battery is a discharging condition, the server may determine the energy output of the low-voltage storage battery based on the energy consumption power of low-voltage electrical device and the target energy compensation parameters.

Exemplary, as shown in FIG. 5, taking the time interval of t2-t3 and the operating condition of the low-voltage storage battery being the discharging condition as an example, the energy output of the low-voltage storage battery may meet the following formula 4.

$$W [ BattDischrg ] = {\int }_{t 2}^{t 3} ( ( P [ Veh ] * Ψ [ Veh ] ) * t ) \qquad ( Formula 4 )$$

Where, t represents any instant within the time interval of t2-t3, P[Veh] represents the energy consumption power of the low-voltage electrical device at time t, Ψ[Veh] represents the target energy consumption compensation parameter at time t, and W[BattDischrg] represents the energy output of the low-voltage storage battery during the time interval of t2-t3.

S403, determine the current remaining energy of the low-voltage storage battery based on the energy input and energy output of the low-voltage storage battery.

Exemplary, combining with FIG. 5, taking the calculation of the current remaining energy of the low-voltage storage battery at time t3 as an example, the server may determine the energy input of the low-voltage storage battery with reference to the above Formula 3 and determine the energy output of the low-voltage storage battery based on Formula 4. Subsequently, the server may determine the remaining energy of the low-voltage storage battery at time t3 with reference to the following Formula 5.

W[Batt]=W[Batt]′+W[BattChrg]−W[BattDischrg] (Formula 5)

Where, W[Batt] represents the remaining energy of the low-voltage storage battery at time t3, W[Batt]′ represents the remaining energy of the low-voltage storage battery at time t1, W[BattDischrg] represents the energy output of the low-voltage storage battery during the time interval of t2-t3, and W[BattChrg] represents the energy input of the low-voltage storage battery during the time interval of t1-t2.

In one possible implementation, when detecting the voltage of the low-voltage storage battery U[Batt]=12.00±0.05V, the server may reset the current remaining energy W[Batt] of the low-voltage storage battery to zero, i.e., W[Batt]=0 Wh.

Based on the above technical solution, the present application comprehensively considers multi-dimensional information including the voltage of the low-voltage storage battery, the output power and the operating state of the DC conversion device, the energy consumption power of the low-voltage electrical device, the energy consumption compensation parameters, and the charge-discharge parameters, which enables more precise determination of the current remaining energy of the low-voltage storage battery, thereby providing a reliable data foundation for subsequently determining the remaining discharging duration of the low-voltage storage battery.

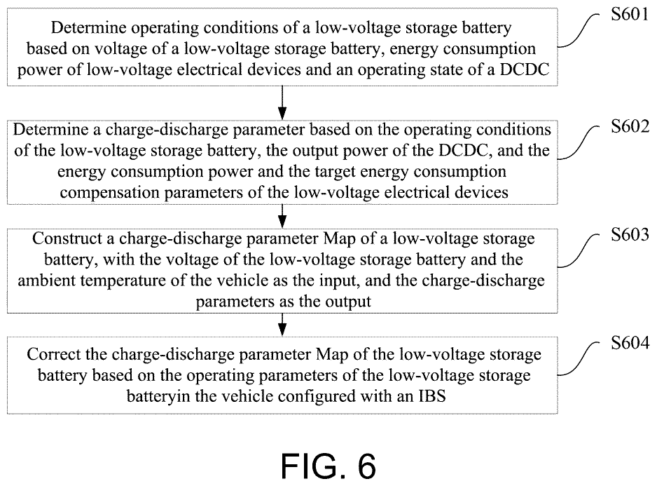

In some embodiments, as shown in FIG. 6, the above charge-discharge parameter Map of the low-voltage storage battery may be obtained through the following steps S601-S604.

S601, determine operating conditions of a low-voltage storage battery based on voltage of a low-voltage storage battery, energy consumption power of low-voltage electrical devices and an operating state of a DCDC.

In one possible implementation, when the DCDC is in a non-operating state, if a voltage variation of the low-voltage storage battery corresponds to an energy consumption power variation of the low-voltage electrical device, the server may determine that the operating condition of the low-voltage storage battery is a discharging condition.

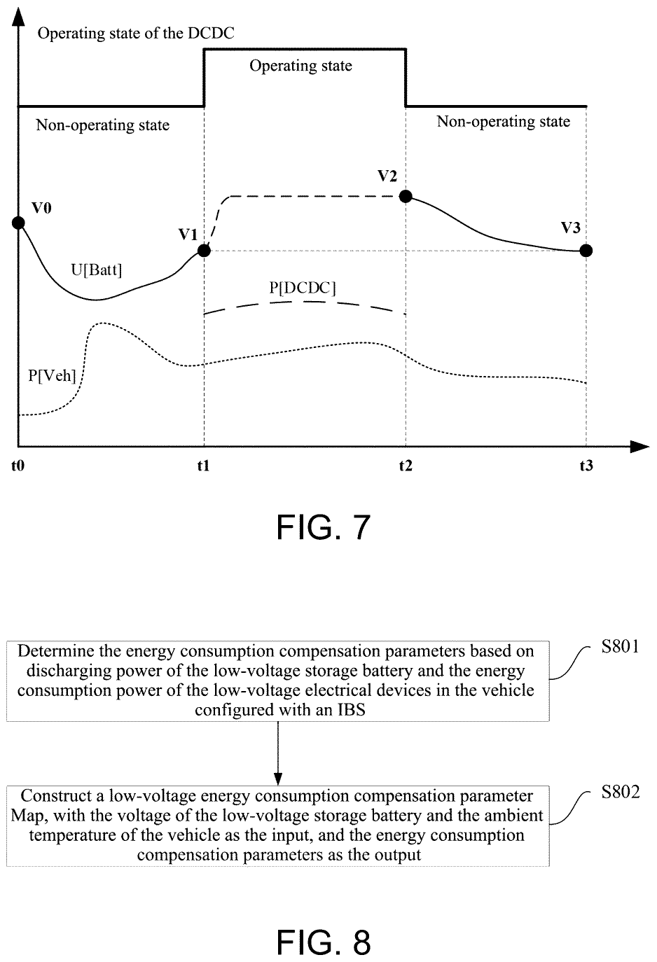

For example, as shown in FIG. 7, during the time interval of t2-t3, the DCDC is in a non-operating state. Both a variation curve of the energy consumption power P[Veh] of the low-voltage electrical device and a variation curve of the voltage U[Batt] of the low-voltage storage battery show small fluctuations and a smooth decrease. Under these conditions, the server may determine that the operating condition of the low-voltage storage battery is a discharging condition.

During the time interval of t0-t1, when the DCDC is in a non-operating state, and the energy consumption power P[Veh] of the low-voltage electrical device exhibits significant fluctuations, with the voltage U[Batt] of the low-voltage storage battery reaching a trough state at a peak of these fluctuations, in this case, the server may determine that the operating condition of the low-voltage storage battery is a discharging condition.

In another possible implementation, when the DCDC is in an operating state, if a difference between the energy consumption power of the low-voltage electrical device when the DCDC enters the operating state and that of the low-voltage electrical device when the DCDC exits the operating state is less than or equal to a preset threshold, and the voltage of the low-voltage storage battery when the DCDC exits the operating state is greater than that of the low-voltage storage battery when the DCDC enters the operating state, the server may determine that the operating condition of the low-voltage storage battery is a charging condition.

Alternatively, when the DCDC is in an operating state, if the output power of the DCDC is greater than the energy consumption power of the low-voltage electrical device, the server may determine that the operating condition of the low-voltage storage battery is a charging condition.

For example, as shown in FIG. 7, during the time interval of t1-t2, the DCDC is in an operating state, and the energy consumption power P[Veh] of the low-voltage electrical device at time t2 is equal to the energy consumption power P[Veh] of the low-voltage electrical device at time t1. Furthermore, the voltage U[Batt] (V2) of the low-voltage storage battery at time t2 is greater than the voltage U[Batt] (V1) of the low-voltage storage battery at time t1. Therefore, the server may determine that the operating condition of the low-voltage storage battery is a charging condition.

For another example, as shown in FIG. 7, during the time interval of t1-t2, the DCDC is in a non-operating state, and the output power P[DCDC] of the DCDC is greater than the energy consumption power P[Veh] of the low-voltage electrical device. Therefore, the server may determine that the operating condition of the low-voltage storage battery is a charging condition.

S602, determine a charge-discharge parameter based on the operating conditions of the low-voltage storage battery, the output power of the DCDC, and the energy consumption power and the target energy consumption compensation parameters of the low-voltage electrical devices.

In one possible implementation, when the operating condition of the low-voltage storage battery is a charging condition, the server may determine a total charging energy of the low-voltage storage battery based on the output power of the DCDC, the energy consumption power of the low-voltage electrical device, and the target energy consumption compensation parameters. When the operating condition of the low-voltage storage battery is a discharging condition, the server may determine a total discharging energy of the low-voltage storage battery based on the energy consumption power of the low-voltage electrical device and the target energy consumption compensation parameters. Subsequently, the server may take a ratio of the total discharging energy of the low-voltage battery to the total charging energy as a charge-discharge coefficient.

Exemplary, combining with FIG. 7, taking the time interval of t1-t3 as an example, the total charging energy of the low-voltage storage battery satisfies the following Formula 6, the total discharging energy of the low-voltage storage battery satisfies Formula 7, and the charge-discharge coefficient satisfies the following Formula 8.

$$W [ i ] = {\int }_{t 1}^{t 2} ( ( P [ DCDC ] - P [ Veh ] * Ψ [ Veh ] ) * t ) * Ψ [ Batt ] \qquad ( Formua 6 )$$

Where, W[i] represents the total charging energy of the low-voltage storage battery, i.e., as shown in FIG. 7, the energy input of the low-voltage storage battery from time t1 to time t2, with W[i] measured in Wh. The meanings of P[DCDC], P[Veh], Ψ[Veh] and t may refer to the explanation of Formula 3 above and are not repeated here.

$$W [ o ] = {\int }_{t 2}^{t 3} ( ( P [ Veh ] * Ψ [ Veh ] ) * t ) \qquad ( Formula 7 )$$

Where, W[o] represents the total energy discharged by the low-voltage storage battery, that is, as shown in FIG. 7, the energy released by the low-voltage storage battery from time t2 to time t3, where from time t2, the low-voltage storage battery stops charging and begins discharging, until time t3, the voltage V3 of the low-voltage storage battery equals to the voltage V1 at time t1. The meanings of P[Veh] and Ψ[Veh] may refer to the explanation of above Formula 3 and are not be repeated here.

$$Ψ [ Batt ] = \frac{W [ o ]}{W [ i ]} \qquad ( Formula 8 )$$

Where, Ψ[Batt] represents the charge-discharge parameters.

S603, construct a charge-discharge parameter Map of a low-voltage storage battery, with the voltage of the low-voltage storage battery and the ambient temperature of the vehicle as the input, and the charge-discharge parameters as the output.

S604, correct the charge-discharge parameter Map of the low-voltage storage battery based on the operating parameters of the low-voltage storage battery in the vehicle configured with an IBS.

In one possible implementation, the server receives operational parameters of the low-voltage storage battery in the vehicle configured with the IBS. On this basis, the server uses operational parameters of the same type of low-voltage batteries collected by the IBS as a standard to correct the charge-discharge parameters in the charge-discharge parameter Map of the low-voltage storage battery, thereby obtaining more accurate charge-discharge parameters.

Based on the above technical solution, by constructing the charge-discharge parameter Map of the low-voltage storage battery, with the voltage of the low-voltage storage battery and the ambient temperature of the vehicle as the input, and the charge-discharge parameters as the output, it may provide support for determining the current remaining energy of the low-voltage storage battery in the subsequent process. Simultaneously, by monitoring and analyzing the changes of these parameters, a trend of the performance of the low-voltage storage battery over time may be identified, providing a basis for judging the lifespan status of the low-voltage storage battery.

In some embodiments, as shown in FIG. 8, the above low-voltage energy consumption compensation parameter Map may be obtained through the following steps S801-S802.

S801, determine the energy consumption compensation parameters based on discharging power of the low-voltage storage battery and the energy consumption power of the low-voltage electrical devices in the vehicle configured with an IBS.

Exemplary, a calculation formula for the energy consumption compensation parameter may refer to the following Formula 9.

$$Ψ [ Veh ] = \frac{P [ Act ]}{P [ Veh ]} \qquad ( Formula 9 )$$

Where, P[Act] represents the discharging power of the low-voltage storage battery (also known as the actual discharging power of the low-voltage storage battery), P[Veh] represents the energy consumption power of the low-voltage electrical device (also known as the real-time energy consumption power of the low-voltage components of the vehicle), and Ψ[Veh] represents the energy consumption compensation parameter.

S802, construct a low-voltage energy consumption compensation parameter Map, with the voltage of the low-voltage storage battery and the ambient temperature of the vehicle as the input, and the energy consumption compensation parameters as the output.

Based on the above technical solution, by constructing the charge-discharge parameter Map of the low-voltage storage battery, with the voltage of the low-voltage storage battery and the ambient temperature of the vehicle as the input, and the energy consumption compensation parameters as the output, it may provide support for determining the current remaining energy and the remaining discharging duration of the low-voltage storage battery in the subsequent process. Simultaneously, the energy consumption compensation parameter may be used to correct the energy consumption power of the low-voltage electrical device to obtain energy consumption power that aligns with actual conditions, thereby improving the accuracy of remaining discharging duration estimation.

In some embodiments, the method provided by the present application may further include: determining the dark current energy consumption power of the low-voltage storage battery.

In one possible implementation, by using the above method described in S401-S403, the server may determine the remaining energy of the low-voltage storage battery when the vehicle enters the dormant state and the remaining energy of the low-voltage storage battery when the vehicle exits the dormant state. Subsequently, the server may determine the remaining energy of the low-voltage storage battery when the vehicle enters the dormant state, the remaining energy of the low-voltage storage battery when the vehicle exits the dormant state, and the time when the vehicle is in a dormant state, and determine the dark current energy consumption power of the low-voltage storage battery.

In one example, as shown in FIG. 5, taking the time interval of t3-t4 as an example where the vehicle is in a dormant state. After the vehicle wakes up at time t4, the DCDC does not enter the operating state, and the low-voltage storage battery continues to discharge until time t5, where at time t5, the voltage of the low-voltage storage battery V1a=12.00±0.05 V. In this case, the server may calculate the energy output W[BattDischrg]_t4~t5 of the low-voltage storage battery during the time interval of t4-t5 using the above formula 4. Subsequently, the remaining energy W[Batt]_t4 of the low-voltage storage battery at time t4 may be determined using the following Formula 10. Additionally, the server may calculate the remaining energy W[Batt]_t3 of the low-voltage storage battery at time t3 using the above Formula 5.

W[Batt]_t4=W[BattDischrg]_t4~t5 (Formula 10)

Based on the above, the server may determine the dark current energy consumption power P[Sleep] during the time interval of t3-t4 based on the remaining energy W[Batt]_t3 of the low-voltage storage battery, the remaining energy W[Batt]_t4 of the low-voltage storage battery, and the duration of the time interval of t3-t4. The specific calculation formula may refer to the following Formula 11.

$$P [ Sleep ] = \frac{W [ Batt ] \_t 3 - W [ Batt ] \_t 4}{t 4 - t 3} \qquad ( Formula 11 )$$

In another example, as shown in FIG. 5, taking the time interval of t3-t4 as an example where the vehicle is in a dormant state. After the vehicle wakes up at time t4, the DCDC does not enter the operating state, and the low-voltage storage battery continues to discharge until time t5, where at time t5, the voltage of the low-voltage storage battery V1>12.00±0.05 V. Subsequently, the DCDC enters the operating state to charge the low-voltage storage battery until time t6, when the output power P[DCDC] of the DCDC equals to P[Veh]*Ψ[Veh] (i.e., the low-voltage storage battery is fully charged). Assuming that the ambient temperature of the vehicle does not change significantly, in this case, the server may calculate the remaining energy W[Batt]_t6 of the low-voltage storage battery at time t6 using the following formula 12. That is, the remaining energy of the low-voltage storage battery at time t6 equals to the remaining energy when the previous DCDC entered its operating state.

W[Batt]_t6=W[Batt]_t2 (Formula 12)

Where, W[Batt]_t2 represents the remaining energy of the low-voltage storage battery at time t2, which may be calculated using the above Formula 5.

Based on the above, the server may calculate the remaining energy W[Batt]_t4 of the low-voltage storage battery at time t4 using the following Formula 13. Subsequently, the server may calculate the dark current energy consumption power P[Sleep] during the time interval of t3-t4 using the above Formula 11.

W[Batt]_t4=W[Batt]_t2−W[BattChrg]_t5~t6+W[BattDischrg]_t4~t5 (Formula 13)

Where, W[BattChrg]_t5~t6 represents the energy input of the low-voltage storage battery during the time interval of t5~t6, and W[BattDischrg]_t4~t5 represents the energy output of the low-voltage storage battery during the time interval of t4-t5.

Based on the above technical solution, the present application determines the remaining energy of low-voltage storage battery when the vehicle enters the dormant state and the remaining energy of the low-voltage storage battery when vehicle exits the dormant state, and further calculates the dark current energy consumption power, which enables assessing energy loss of the low-voltage storage battery during a dormant period accurately, thereby holding a significant importance for optimizing vehicle electrical system design and reducing energy consumption during the dormant period.

In some embodiments, the method provided by the embodiments of the present application may further include: monitoring abnormal dark current conditions of the low-voltage storage battery.

In one possible implementation, the server may determine multiple dark current energy consumption powers of the low-voltage storage battery within a first preset time interval. If the number of the target dark current energy consumption power among multiple dark current energy consumption powers is greater than the first quantity threshold, the server may send a message of dark current abnormity to the vehicle and the terminal device, to alert the user of abnormal dark current during a dormant state of the vehicle.

Where, the target dark current energy consumption power value is greater than the energy consumption threshold.

In the embodiments of the present application, the first quantity threshold may be determined based on actual requirements. For example, the first quantity threshold may be 5, 10, 20, etc., there is no limitation on this.

Exemplary, assuming the first quantity threshold is 2, assuming that during the time interval of t1-t5, the dark current energy consumption powers at times t1 and t3 are less than the energy consumption threshold, and the dark current energy consumption powers at times t2, t4, and t5 are greater than the energy consumption threshold, in this case, the server may send the message of dark current abnormity to the vehicle and terminal device.

Based on the above technical solution, by monitoring dark current energy consumption in real time and outputting the message of dark current abnormity when a warning condition is triggered, it enables users or maintenance personnel of the vehicle to promptly identify the abnormal condition of the battery, allowing them to take corresponding measures to prevent issues such as vehicle failure to start or battery damage caused by excessive power consumption of the battery.

In some embodiments, the method provided by the embodiments of the present application may further include: monitoring the health status of the low-voltage storage battery, where the health status of the low-voltage storage battery may be used to indicate the lifespan status of the low-voltage storage battery.

In one possible implementation, the server may acquire multiple charge-discharge parameters corresponding to the voltage of the low-voltage storage battery and the ambient temperature of the vehicle within a second preset time interval from the charge-discharge parameter Map of low-voltage storage battery. If the number of the target charge-discharge parameter among the multiple charge-discharge parameters is greater than a second quantity threshold, the server may send a health warning message of the low-voltage storage battery to the vehicle and the terminal device, to alert the user that the service life of the low-voltage storage battery is short.

Where, the target charge-discharge parameter value is less than the discharge parameter threshold. Charge-discharge parameters are used to evaluate the lifespan status of the low-voltage storage battery.

In the embodiments of the present application, the second quantity threshold may be determined based on actual requirements. For example, the second quantity threshold may be 5, 10, 20, etc., there is no limitation on this.

Exemplary, assuming the first quantity threshold is 3 and assuming that during the time interval of t1-t5, 4 out of 5 charge-discharge parameters are all greater than the charge-discharge threshold, in this case, the server may send a low-voltage storage battery health warning message to the vehicle and terminal device.

Based on the above technical solution, real-time charge-discharge parameters enable a comprehensive and accurate assessment of the actual lifespan status of the battery. When the warning condition is triggered, through identifying battery health issues of the battery in advance and taking corresponding measures, it may extend a service life of the battery.

In some embodiments, when detecting that it is impossible to communicate with the server, the vehicle determines whether the low-voltage storage battery requires charging based on the operational information of the low-voltage devices and the current state of the vehicle. Subsequently, the vehicle charges the low-voltage storage battery via the DC conversion device when determining that the low-voltage storage battery requires charging.

In one possible implementation, the vehicle may determine whether the low-voltage storage battery requires charging based on the above method described in S302 and S304. Upon determining that the low-voltage storage battery requires charging, the vehicle charges the low-voltage storage battery via the DC conversion device, which is not be repeated here.

If the vehicle is in an awake state but does not detect that the remaining discharging time and/or the voltage of the low-voltage storage battery meets the condition for charging the low-voltage storage battery, the vehicle may determine a future wake-up time based on historical dark current energy consumption and the current remaining energy of the low-voltage storage battery. Subsequently, a low-level scheduled vehicle wake-up task may be established based on the future wake-up time. Upon reaching the future wake-up time, the vehicle is awakened, and it determines whether the low-voltage storage battery requires charging based on the current operational information of the low-voltage devices of the vehicle.

In one possible implementation, when the vehicle could communicate with the server, it may send information such as the operating parameters of the low-voltage device, the remaining energy and the remaining discharge duration of the low-voltage storage battery, and the dark current energy consumption power to the server. Where the above information comes from the period when the vehicle did not communicate with the server.

Based on the above technical solution, in the present application, when detecting that it is impossible to communicate with the server, the vehicle independently determines whether the low-voltage storage battery requires charging based on the operational information of the vehicle's own low-voltage devices and the current state of the vehicle. This ensures that the vehicle may still maintain a normal operation of the charging function even in an event of communication failure, avoiding a situation where the low-voltage storage battery cannot be charged due to the inability to communicate with the server, and thus guarantees the autonomy and stability of the vehicle's energy supply.

In some embodiments, the method provided by the present application may further include: determining, by the vehicle, the energy consumption power of the low-voltage electrical device based on the current and voltage of the low-voltage electrical device.

In the embodiments of the present application, the low-voltage electrical device may include an electrical device directly powered by the low-voltage storage battery terminals (i.e., class A electrical device) and an electrical device powered by pins of the other electrical device (i.e., class B electrical device).

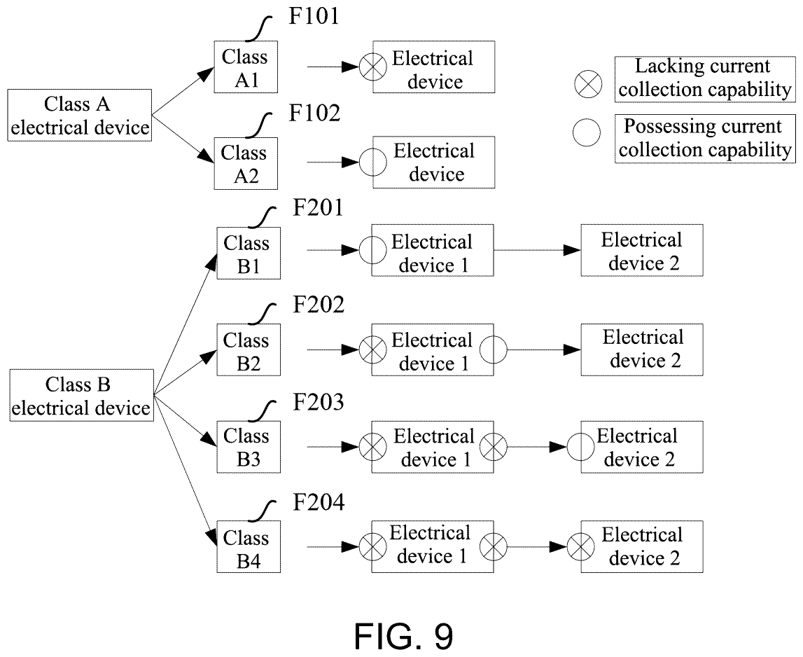

As shown in FIG. 9, based on whether the power input/output terminals of the low-voltage electrical device possess input/output current collecting capability, class A electrical device and class B electrical device may be further categorized into the following types. Class A electrical device includes class A1 F101 electrical device and class A2 F102 electrical device. Class B electrical device includes class B1 F201 electrical device, class B2 F202 electrical device, class B3 F203 electrical device, and class B4 F204 electrical device.

### 1-1. Class A1 F101 Electrical Device.

Where, class A1 F101 electrical device may be directly powered by the terminals of the low-voltage storage battery, and a power input terminal of the electrical device lacks input current collection capability.

### 1-2. Class A2 F102 Electrical Device.

Where, class A2 F102 electrical device may be directly powered by the terminals of low-voltage storage battery, and a power input terminal of the electrical device possesses the input current collection capability.

### 1-3. Class B1 F201 Electrical Device.

Where, class B1 F201 electrical device 2 is powered by pins of electrical device 1, and the power input terminal of electrical device 1 possesses current collection capability.

### 1-4. Class B2 F202 Electrical Device.

Where, class B2 F202 electrical device 2 is powered by the pins of electrical device 1, the power input terminal of electrical device 1 lacks current collection capability, and the power output terminal of electrical device 1 possesses current collection capability.

### 1-5. Class B3 F203 Electrical Device.

Where, class B3 F203 electrical device 2 is powered by the pins of electrical device 1. Neither power input terminals nor power output terminals of electrical device 1 possess current collection capability, and a power input terminal of electrical device 2 possesses current collection capability.

### 1-6. Class B4 F204 Electrical Device.

Where, class B4 F204 electrical device 2 is powered by the pins of electrical device 1. Neither power input terminals nor power output terminals of electrical device 1 possess current collection capability, and the power input terminal of electrical device 2 lacks current collection capability.

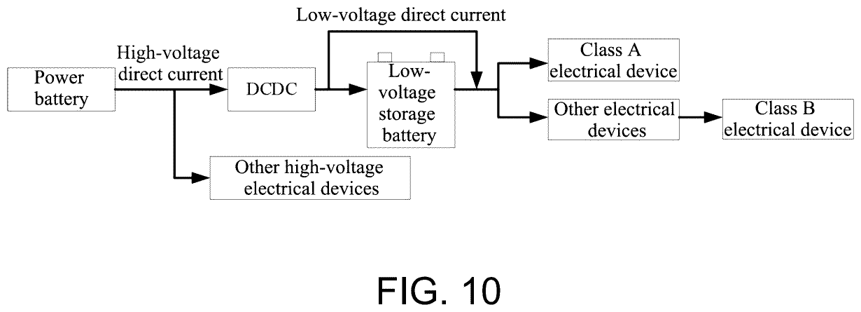

It should be noted that, as shown in FIG. 10, the above power supply process primarily involves: the DCDC may convert the high-voltage direct current from the power battery into low-voltage direct current to charge the low-voltage storage battery. Subsequently, the low-voltage storage battery may directly supply power to class A electrical device, and class B electrical device may be powered by the other electrical device. The power battery may also supply power to other high-voltage electrical devices.

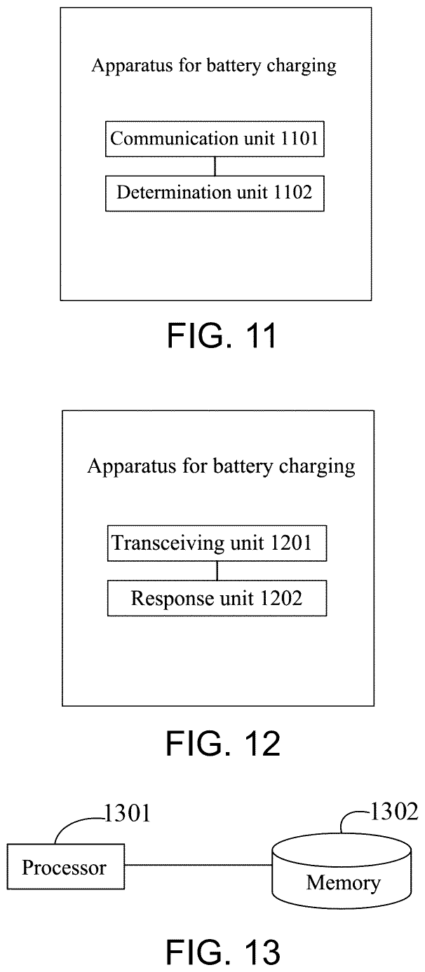

In one possible implementation, as shown in FIG. 11, each electrical device sends its energy consumption power to the vehicle, and the vehicle may determine the energy consumption powers of the low-voltage electrical devices of the vehicle based on the energy consumption power from each device. Where, combining with FIG. 9, the energy consumption power calculation standards for different electrical devices may refer to Table 1 below.

TABLE 1
Energy Consumption Power Calculation Standards
for Different Electrical Devices

| Power | |
|---|---|
| supply mode | Energy consumption power calculation standards |
| Class A1 | A controlling party for class A1 electrical device estimates a real- |
| | time input current of class A1 electrical device based on operational |
| | characteristics, hardware features, control methods, fault states, etc. |
| | of class A1 electrical device, and calculates the energy consumption |
| | power of class A1 electrical device based on the real-time input |
| | current of class A1 electrical device |
| Class A2 | Calculating the energy consumption power of the class A2 |
| | electrical device based on the real-time input current of the class A2 |
| | electrical device collected by the device itself |
| Class B1 | Calculating the real-time power of the class B1 electrical device |
| | based on the real-time input current of the electrical device 1 collected |
| | by the device itself |
| Class B2 | Determining the real-time input current of the electrical device 1 |
| | based on the voltage of the electrical device 1 and the output current |
| | of the electrical device 1 collected by the device itself, and calculating |
| | the energy consumption power of the class B2 electrical device based |
| | on the real-time input current of the electrical device 1 |
| Class B3 | Determining the input current of the electrical device 1 based on |
| | the voltage of the electrical device 2 and the real-time input current of |
| | the electrical device 2 collected by the device itself, and calculating |
| | the energy consumption power of the class B3 electrical device based |
| | on the input current of the electrical device 1 |
| Class B4 | A controlling party for class B4 electrical device estimates a real- |
| | time input current of the class B4 electrical device based on |
| | operational characteristics, hardware features, control methods, fault |
| | states, etc. of the class B4 electrical device, and calculates the energy |
| | consumption power of the class B4 electrical device based on the real- |
| | time input current of the class B4 electrical device |

The above primarily introduces the solutions provided by the embodiments of the present application from a methodological perspective. To achieve the above functions, a resource scheduling device or an electronic device incorporates hardware structures and/or software modules corresponding to the execution of each function. Those skilled in the art will readily appreciate that, based on the units and algorithmic steps described in the embodiments disclosed herein, the present application may be implemented in hardware, or in a combination of hardware and computer software. Whether a particular function is executed via hardware or computer software driving hardware depends on a specific application and design constraints of the technical solution. Professional technical personnel may employ different methods to implement the described functions for each specific application, but such implementations should not be considered as beyond the scope of the present application.

FIG. 11 is a block diagram of an apparatus for battery charging provided by an embodiment of the present application, applied to a server. As shown in FIG. 11, the apparatus includes: a communication unit 1101 and a determination unit 1102.

The communication unit 1101 is configured to receive operational information of low-voltage devices and a current state of a vehicle from the vehicle; where the low-voltage devices include a low-voltage storage battery and a DC conversion device.

The determination unit 1102 is configured to determine whether the low-voltage storage battery requires charging based on the operational information of low-voltage devices and the current state of the vehicle.

The communication unit 1101 is further configured to send a high-voltage power-on instruction to the vehicle when determining that the low-voltage storage battery requires charging, to enable the vehicle to charge the low-voltage storage battery via the DC conversion device.

In one possible implementation, the determination unit 1102 is further configured to, determine whether the low-voltage storage battery requires charging based on the current state of the vehicle and the energy information of the low-voltage storage battery.

In one possible implementation, the determination unit 1102 is further configured to, when the current state of the vehicle is a wake-up state, if the voltage of the low-voltage storage battery is less than or equal to a voltage threshold, and/or the remaining discharging duration of the low-voltage storage battery is less than or equal to a discharging duration threshold, determine that the low-voltage storage battery requires charging; and if the voltage of the low-voltage storage battery is greater than the voltage threshold, and/or the remaining discharging duration of the low-voltage storage battery is greater than the discharging duration threshold, determine that the low-voltage storage battery does not require charging.

In one possible implementation, the determination unit 1102 is further configured to, when the current state of the vehicle is a dormant state, if the remaining discharging duration of the low-voltage storage battery is less than or equal to a discharging duration threshold, determine that the low-voltage storage battery requires charging; and if the remaining discharging duration of the low-voltage storage battery is greater than the discharging duration threshold, determine that the low-voltage storage battery does not require charging.

In one possible implementation, the determination unit 1102 is further configured to, determine the remaining discharging duration of the low-voltage storage battery based on the operational information of the low-voltage devices, a current operating state of the vehicle, and the target energy consumption compensation parameters.

In one possible implementation, the determination unit 1102 is further configured to, determine a current remaining energy of the low-voltage storage battery based on the voltage of the low-voltage storage battery, an output power and an operating state of the DC conversion device, energy consumption power of the low-voltage electrical devices, and the target energy consumption compensation parameters.

In one possible implementation, the determination unit 1102 is further configured to, determine the remaining discharging duration of the low-voltage storage battery based on the current operating state of the vehicle and the current remaining energy of the low-voltage storage battery.

In one possible implementation, the determination unit 1102 is further configured to, when the current state of the vehicle is a wake-up state, determine target energy consumption power of the low-voltage electrical devices based on the energy consumption power of the low-voltage electrical devices and the target energy consumption compensation parameters.

In one possible implementation, the determination unit 1102 is further configured to, determine the remaining discharging duration of the low-voltage storage battery based on the current remaining energy of the low-voltage storage battery and the target energy consumption power of the low-voltage electrical devices.

In one possible implementation, the determination unit 1102 is further configured to, when the current state of the vehicle is a dormant state, determine a remaining energy of the low-voltage storage battery when the vehicle enters the dormant state and a remaining energy of the low-voltage storage battery when the vehicle exits the dormant state.

In one possible implementation, the determination unit 1102 is further configured to, determine a dark current energy consumption power of the low-voltage storage battery based on the remaining energy of the low-voltage storage battery when the vehicle enters the dormant state and the remaining energy of the low-voltage storage battery when the vehicle exits the dormant state.

In one possible implementation, the determination unit 1102 is further configured to, determine the remaining discharging duration of the low-voltage storage battery based on the dark current energy consumption power and the current remaining energy of the low-voltage storage battery.

FIG. 12 is a block diagram of another apparatus for battery charging provided by an embodiment of the present application, applied to a vehicle. As shown in FIG. 12, the apparatus includes: a transceiving unit 1201 and a response unit 1202.

The transceiving unit 1201, is configured to send operational information of low-voltage devices and a current state of a vehicle to a server, so that the server determines whether the low-voltage storage battery requires charging based on the operational information of the low-voltage devices and the current state of the vehicle; where the low-voltage devices include the low-voltage storage battery and a DC conversion device.

The transceiving unit 1201 is further configured to receive a high-voltage power-on instruction sent by the server; where the high-voltage power-on instruction is sent by the server when determining that the low-voltage storage battery requires charging.

The response unit 1202 is configured to charge the low-voltage storage battery via the DC conversion device in response to the high-voltage power-on instruction.

FIG. 13 is a block diagram of an electronic device provided by an embodiment of the present application. As shown in FIG. 13, the electronic device includes, but is not limited to, a processor 1301 and a memory 1302.

Where, the memory 1302 is used to store executable instructions of the processor 1301. It should be understood that the processor 1301 is configured to execute the instructions to implement the method for battery charging described in the above embodiments.

It should be noted that those skilled in the art will appreciate that the structure of the electronic device illustrated in FIG. 13 does not constitute a limitation on the electronic device. The electronic device may include more or fewer components than those shown in FIG. 13, combine certain components, or have different component arrangements.

The processor 1301, serving as a control center of the electronic device, connects various parts of the electronic device through interfaces and lines, and executes various functions and processes data of the electronic device by running or executing software programs and/or modules stored in the memory 1302, as well as calling data stored in the memory 1302, thereby providing overall control of the electronic device. The processor 1301 may include one or more processing units. In one possible implementation, the processor 1301 may integrate an application processor and a modem processor, where the application processor primarily handles an operating system, a user interface, an application, etc., while the modem processor primarily handles wireless communication. It should be understood that the above modem processor may not be integrated into the processor 1301.

The memory 1302 may be used to store software programs and various data. The memory 1302 may primarily include a program storage area and a data storage area. Where the program storage area may store the operating system and applications required by at least one functional module (e.g., a determination unit, a processing unit, etc.). Additionally, the memory 1302 may include a high-speed random access memory and may further include a non-volatile memory, such as at least one disk storage device, a flash memory device, or other volatile solid-state storage device.

In an exemplary embodiment, a computer-readable storage medium containing instructions is further provided, such as a memory 1302 containing instructions. These instructions may be executed by the processor 1301 of the electronic device to implement the method described in the above embodiments.

In actual implementation, the functions of the communication unit 1101 and the determination unit 1102 in FIG. 11, as well as the transceiving unit 1201 and the response unit 1202 in FIG. 12, may be realized by the processor 1301 in FIG. 13 invoking a computer program stored in the memory 1302. The specific execution process may refer to the description in the method section of the above embodiments and is not repeated here.

In one possible implementation, the computer-readable storage medium may be a non-transitory computer-readable storage medium. For example, such a non-transitory computer-readable storage medium may be a read-only memory (ROM), a random access memory (RAM), a CD-ROM, a magnetic tape, a floppy disk, or an optical data storage device.

In exemplary embodiments, the present application further provides a computer program product comprising one or more instructions. The one or more instructions may be executed by a processor 1301 of an electronic device to implement the method described in the above embodiments.

It should be noted that the various processes of the above method embodiments are implemented when one or more instructions in the above computer-readable storage medium or computer program product are executed by a processor of an electronic device, achieving the same technical effect as those of the aforementioned method. To avoid repetition, further details are not repeated here.

Through the above description of the implementations, those skilled in the art may clearly understand that, for the sake of convenience and simplicity in the description, only the above division of functional modules is given as an example for illustration. In actual applications, according to the needs, the above functions can be assigned to different functional modules for completion, that is, the internal structure of the apparatus can be divided into different functional modules to complete all or part of the functions described above.

In the embodiments provided herein, it should be understood that the disclosed apparatuses and methods may be implemented through other means. For example, the apparatus embodiments described above are merely illustrative. The division of modules or units represents only a logical functional partitioning; and there may be other division methods in actual implementation. For example, multiple units or components may be combined or integrated into another apparatus, or certain features may be omitted or not executed. Furthermore, the mutual coupling or the direct coupling or the communication connection shown or discussed may be indirect coupling or communication connection through interfaces, devices, or units, and may be in electrical, mechanical, or other forms.

Units described as separate components may or may not be physically separated. Components depicted as units may constitute a single physical unit or multiple physical units, i.e., they may be located in one place or distributed across multiple different locations. Depending on practical requirements, some or all of these units may be selected to achieve the objectives of the present embodiment.

Additionally, the functional units in each embodiment of the present application may be integrated into a single processing unit, or exist as separate physical units, or two or more units may be integrated into a single unit. The integrated units may be implemented either in a hardware form or as software functional units.

When integrated units are implemented as software functional units and sold or used as independent products, they may be stored in a readable storage medium. Based on this understanding, the technical solutions of the embodiments of the present application, in essence or in the portion contributing to the prior art, or the entirety or part of such technical solutions, may be embodied as a software product. This software product is stored in a storage medium and includes a plurality of instructions for causing a device (such as a microcontroller, a chip, etc.) or a processor to execute all or part of the steps of the methods of the various embodiments of the present application. The above storage media include: USB drives, portable hard drives, a ROM, a RAM, magnetic disks, optical discs, and other media capable of storing a program code.

The foregoing describes specific implementations of the present application. However, the scope of protection of the present application is not limited thereto. Any variation or substitution within the technical scope disclosed the present application should be encompassed within the scope of protection of the present application. Therefore, the scope of protection of the present application shall be subjected to the scope of the claims.

What is claimed is:

1. A method for battery charging, applied to a server, comprising:
receiving operational information of low-voltage devices and a current state of a vehicle from the vehicle; wherein the low-voltage devices comprise a low-voltage storage battery and a direct current (DC) conversion device; and the operational information of the low-voltage devices comprises energy information of the low-voltage storage battery;
determining whether the low-voltage storage battery requires charging based on the energy information of the low-voltage storage battery and the current state of the vehicle; wherein the energy information of the low-voltage storage battery comprises remaining discharging duration of the low-voltage storage battery and/or a voltage of the low-voltage storage battery;
when determining that the low-voltage storage battery requires charging, sending a high-voltage power-on instruction to the vehicle to enable the vehicle to charge the low-voltage storage battery via the DC conversion device.

2. The method according to claim 1, wherein the determining whether the low-voltage storage battery requires charging based on the energy information of the low-voltage storage battery and the current state of the vehicle, comprises:
when the current state of the vehicle is a wake-up state, if the voltage of the low-voltage storage battery is less than or equal to a voltage threshold, and/or the remaining discharging duration of the low-voltage storage battery is less than or equal to a discharging duration threshold, determining that the low-voltage storage battery requires charging;
when the current state of the vehicle is the wake-up state, if the voltage of the low-voltage storage battery is greater than the voltage threshold, and/or the remaining discharging duration of the low-voltage storage battery is greater than the discharging duration threshold, determining that the low-voltage storage battery does not require charging.

3. The method according to claim 1, wherein the determining whether the low-voltage storage battery requires charging based on the energy information of the low-voltage storage battery and the current state of the vehicle, comprises:
when the current state of the vehicle is a dormant state, if the remaining discharging duration of the low-voltage storage battery is less than or equal to a discharging duration threshold, determining that the low-voltage storage battery requires charging;
when the current state of the vehicle is the dormant state, if the remaining discharging duration of the low-voltage storage battery is greater than the discharging duration threshold, determining that the low-voltage storage battery does not require charging.

4. The method according to claim 1, wherein the method further comprises:
acquiring target energy consumption compensation parameters corresponding to the voltage of the low-voltage storage battery and a current ambient temperature of the vehicle;
determining the remaining discharging duration of the low-voltage storage battery based on the operational information of the low-voltage devices, a current operating state of the vehicle, and the target energy consumption compensation parameters.

5. The method according to claim 4, wherein the low-voltage devices further comprise low-voltage electrical devices;
the determining the remaining discharging duration of the low-voltage storage battery based on the operational information of the low-voltage devices, the current operating state of the vehicle, and the target energy consumption compensation parameters, comprising:
determining a current remaining energy of the low-voltage storage battery based on the voltage of the low-voltage storage battery, an output power and an operating state of the DC conversion device, energy consumption power of the low-voltage electrical devices, and the target energy consumption compensation parameters;
determining the remaining discharging duration of the low-voltage storage battery based on the current operating state of the vehicle and the current remaining energy of the low-voltage storage battery.

6. The method according to claim 5, wherein the determining the remaining discharging duration of the low-voltage storage battery based on the current operating state of the vehicle and the current remaining energy of the low-voltage storage battery, comprises:
when the current state of the vehicle is a wake-up state, determining target energy consumption power of the low-voltage electrical devices based on the energy consumption power of the low-voltage electrical devices and the target energy consumption compensation parameters;
determining the remaining discharging duration of the low-voltage storage battery based on the current remaining energy of the low-voltage storage battery and the target energy consumption power of the low-voltage electrical devices.

7. The method according to claim 5, wherein the determining the remaining discharging duration of the low-voltage storage battery based on the current operating state of the vehicle and the current remaining energy of the low-voltage storage battery, comprises:
when the current state of the vehicle is a dormant state, determining a remaining energy of the low-voltage storage battery when the vehicle enters the dormant state and a remaining energy of the low-voltage storage battery when the vehicle exits the dormant state;
determining a dark current energy consumption power of the low-voltage storage battery based on the remaining energy of the low-voltage storage battery when the vehicle enters the dormant state and the remaining energy of the low-voltage storage battery when the vehicle exits the dormant state; wherein the dark current energy consumption power refers to a current consumption present in the low-voltage storage battery after the vehicle enters the dormant state;
determining the remaining discharging duration of the low-voltage storage battery based on the dark current energy consumption power and the current remaining energy of the low-voltage storage battery.

8. The method according to claim 1, wherein the method further comprises:
determining multiple dark current energy consumption powers of the low-voltage storage battery within a first preset time interval; wherein the dark current energy consumption power refers to an energy consumed by the low-voltage storage battery after the vehicle enters the dormant state;
based on that the number of a target dark current energy consumption power among the multiple dark current energy consumption powers is greater than a first quantity threshold, outputting a message of dark current abnormity; wherein a value of the target dark current energy consumption power is greater than an energy consumption threshold.

9. The method according to claim 1, wherein the method further comprises:
acquiring multiple charge-discharge parameters corresponding to the voltage of the low-voltage storage battery and the ambient temperature of the vehicle within a second preset time interval; wherein the charge-discharge parameters are used to evaluate a life status of the low-voltage storage battery;
based on that the number of a target charge-discharge parameter among the multiple charge-discharge parameters is greater than a second quantity threshold, outputting a health warning message of the low-voltage storage battery; wherein a value of the target charge-discharge parameter is less than a discharge parameter threshold.

10. A method for battery charging, applied to a vehicle, comprising:
sending operational information of low-voltage devices and a current state of a vehicle to a server, wherein the operational information of the low-voltage devices comprises energy information of a low-voltage storage battery, so that the server determines whether the low-voltage storage battery requires charging based on the energy information of the low-voltage storage battery and the current state of the vehicle; wherein the low-voltage devices comprise the low-voltage storage battery and a direct current (DC) conversion device; and the energy information of the low-voltage storage battery comprises a remaining discharging duration of the low-voltage storage battery and/or a voltage of the low-voltage storage battery;
receiving a high-voltage power-on instruction sent by the server; wherein the high-voltage power-on instruction is sent by the server when determining that the low-voltage storage battery requires charging;
in response to the high-voltage power-on instruction, charging the low-voltage storage battery via the DC conversion device.

11. The method according to claim 10, wherein the method further comprises:
when detecting that the vehicle is unable to communicate with the server, determining whether the low-voltage storage battery requires charging based on the energy information of the low-voltage storage battery and the current state of the vehicle;
when determining that the low-voltage storage battery requires charging, charging the low-voltage storage battery via the DC conversion device.

12. The method according to claim 11, wherein the determining whether the low-voltage storage battery requires charging based on the energy information of the low-voltage storage battery and the current state of the vehicle, comprises:
when the current state of the vehicle is a wake-up state, if the voltage of the low-voltage storage battery is less than or equal to a voltage threshold, and/or the remaining discharging duration of the low-voltage storage battery is less than or equal to a discharging duration threshold, determining that the low-voltage storage battery requires charging;
if the voltage of the low-voltage storage battery is greater than the voltage threshold, and/or the remaining discharging duration of the low-voltage storage battery is greater than the discharging duration threshold, determining that the low-voltage storage battery does not require charging.

13. The method according to claim 11, wherein the determining whether the low-voltage storage battery requires charging based on the energy information of the low-voltage storage battery and the current state of the vehicle, comprises:
when the current state of the vehicle is a dormant state, if the remaining discharging duration of the low-voltage storage battery is less than or equal to a discharging duration threshold, determining that the low-voltage storage battery requires charging;
if the remaining discharging duration of the low-voltage storage battery is greater than the discharging duration threshold, determining that the low-voltage storage battery does not require charging.

14. The method according to claim 10, wherein the low-voltage devices further comprise a low-voltage electrical device, and the method further comprises:
determining energy consumption power of the low-voltage electrical device based on current and voltage of the low-voltage electrical device.

15. An electronic device, comprising: a processor and a memory for storing instructions executable by the processor;
wherein the processor is configured to execute the instructions to implement:
receiving operational information of low-voltage devices and a current state of a vehicle from the vehicle; wherein the low-voltage devices comprise a low-voltage storage battery and a direct current (DC) conversion device; and the operational information of the low-voltage devices comprises energy information of the low-voltage storage battery;
determining whether the low-voltage storage battery requires charging based on the energy information of the low-voltage storage battery and the current state of the vehicle; wherein the energy information of the low-voltage storage battery comprises remaining discharging duration of the low-voltage storage battery and/or a voltage of the low-voltage storage battery;
when determining that the low-voltage storage battery requires charging, sending a high-voltage power-on instruction to the vehicle to enable the vehicle to charge the low-voltage storage battery via the DC conversion device.

16. An electronic device, comprising: a processor and a memory for storing instructions executable by the processor;
wherein the processor is configured to execute the instructions to implement the method according to claim 10.

17. A system for battery charging, comprising a vehicle and a server;
wherein the server is configured to perform the following:
receiving operational information of low-voltage devices and a current state of a vehicle from the vehicle; wherein the low-voltage devices comprise a low-voltage storage battery and a direct current (DC) conversion device; and the operational information of the low-voltage devices comprises energy information of the low-voltage storage battery;
determining whether the low-voltage storage battery requires charging based on the energy information of the low-voltage storage battery and the current state of the vehicle; wherein the energy information of the low-voltage storage battery comprises remaining discharging duration of the low-voltage storage battery and/or a voltage of the low-voltage storage battery;
when determining that the low-voltage storage battery requires charging, sending a high-voltage power-on instruction to the vehicle to enable the vehicle to charge the low-voltage storage battery via the DC conversion device;
wherein the vehicle is configured to perform the method according to claim 10.

18. A vehicle, wherein the vehicle is configured to perform the method according to claim 10.

19. A non-transitory computer readable storage medium, wherein when computer-executable instructions stored in the computer readable storage medium are executed by a processor of a processing apparatus, the processing apparatus is capable of performing the method according to claim 1.

20. A non-transitory computer readable storage medium, wherein when computer-executable instructions stored in the computer readable storage medium are executed by a processor of a processing apparatus, the processing apparatus is capable of performing the method according to claim 10.
